(19) United States
(12) Patent Application Publication
(10) Pub. No.: US 2007/0285096 A1
(43) Pub. Date: Dec. 13, 2007

(54) Double-tuned RF coil

(75) Inventors: Yoshihisa Soutome, Tokyo (JP); Hideta Habara, Musashino (JP); Hisaaki Ochi, Bellevue, WA (US)

Correspondence Address: Stanley P. Fisher;Reed Smith Hazel & Thomas LLP, Suite 1400, 3110 Fairview Park Drive, Falls Church, VA, 22042-4503, US

(73) Assignee: Hitachi, Ltd.

(21) Appl. No.: 11/806,820

(22) Filed: Jun. 4, 2007

(30) Foreign Application Priority Data
Jun. 9, 2006 (JP) 2006-160818

(51) Int. Cl. G01V 3/00

(52) U.S. Cl. 324/318; 324/322

(57) ABSTRACT

An RF coil has at least one conductor loop and a parallel circuit provided with a first branch and a second branch is installed. The first branch has a first capacitor and the second branch has a third capacitor and a first parallel resonance circuit configured by a second capacitor and a first inductor. The first capacitor has capacity to allow the RF coil to resonate at the time of transmission/reception of the first resonance frequency signal corresponding to an element with a higher magnetic resonance frequency, and capacity of the second capacitor and a value of the first inductor are determined as an accumulated value thereof based on the first resonance frequency. The third capacitor has capacity to allow the RF coil to resonate at the time of transmission/reception of the second resonance frequency signal corresponding to an element with a lower magnetic resonance frequency.

### INCORPORATION BY REFERENCE

The present application claims priority from Japanese application JP2006-160818 filed on Jun. 9, 2006, the content of which is hereby incorporated by reference into this application.

### BACKGROUND OF THE INVENTION

1. Field of the Invention

The present invention relates to a magnetic resonance image pickup device (MRI: Magnetic Resonance Imaging) and, in particular, relates to an RF coil for detecting two types of magnetic resonance signal different in frequency.

2. Description of the Related Art

A magnetic resonance image pickup device is a medical imaging diagnostic device for making nuclei in any cross-section crossing a test subject cause magnetic resonance and obtaining a tomography image in that section from the generated magnetic resonance signals.

The MRS (magnetic resonance spectroscopy) being a type of magnetic resonance image pickup method and the MRSI (magnetic resonance spectroscopic imaging) is used as a method for measuring a metabolic state in vivo. Here, the MRS is a method for measuring frequency distribution of magnetic resonance signals sent out from matter and the MRSI is a method for imaging based on a specific frequency component in magnetic resonance signals having frequency distribution. Those image pickup methods include a method for picking up magnetic resonance images with nucleus other than the ¹H nucleus such as ¹⁹F (fluorine), ³¹P (phosphorus), ²³Na (sodium) in addition to image pickup with magnetic resonance signals of proton (1H). In order to obtain magnetic resonance images of ¹H nucleus and the other atomic nucleus simultaneously, it is necessary to cause the RF coil to come into synchronization at magnetic resonance frequency of ¹H nucleus and the other atomic nucleus. Such a coil is called a double-tuned RF coil.

A conventional double-tuned RF coil is known as a double-tuned RF loop coil including a trap circuit configured by an inductor and a capacitor connected in parallel and inserted into the loop of the coil as illustrated in FIG. 20 (see JP-A-6-242202 and M. D. Schnall et al, “A New Double-Tuned Probe for Concurrent 1H and 31P NMR”, Journal of Magnetic Resonance 65, 122-129 (1985), for example) and as a double-tuned RF coil in which a trap circuit configured by an inductor and a capacitor being inserted in a birdcage RF coil allowing uniform RF magnetic field generation and uniformalizing detection sensitivity (see JP-B-3295851 and Alan R. Rath et al, “Design and Performance of a Double-Tuned Bird-Cage Coil”, Journal of Magnetic Resonance 86, 488-495 (1990), for example). However, the adoption of those double-tuned RF coils assumes presence of ¹H and ³¹P with two tuned magnetic resonance frequencies mutually set apart. Therefore, in the case where two tuned frequencies are near each other, realization of double tuning requires the value of inductor and capacitor for use in a trap circuit to be not less than 1 μH or not less than 1 nF. For the inductor and the capacitor having such a large value, high frequency loss of the element itself will no longer be ignorable with not less than 1 MHz, giving rise to a problem of an advent of decrease in sensitivity as well as transmit efficiency of the RF coil.

In addition, taking ¹H and ¹⁹F with the proportion of the magnetic resonance frequency being 1:0.94 as examples for a double-tuned RF coil that operates in the case where the two magnetic resonance frequencies are near each other, FIG. 21 illustrates a saddle double-tuned coil disposed in a location where a saddle RF coil which comes into resonance with ¹⁹F and a saddle RF coil which comes into resonance with ¹H are caused to orthogonal with each other and a double-tuned RF coil that brings the coils into resonance at magnetic resonance frequencies of ¹⁹F and ¹H by partly varying the value of capacitor of the birdcage RF coil (see, for example, Peter M. Joseph et al, “A Technique for Double Resonant Operation of Birdcage Imaging Coils”, IEEE Transactions on Medical Imaging, Vol. 8, NO. 3, September 1989, pp. 286-294). However, those RF coils are significantly different each other in sensitivity distribution of coil corresponding with two types of magnetic resonance signals, giving rise, therefore, a problem that the region where good sensitivity is obtainable for both of the signals is limited. In addition, those RF coils give rise to such a problem that no QD (quadrature) system enabling improvement by 1.4-times larger in sensitivity is adoptable and no sufficient sensitivity compared with an RF coil in the QD system is obtainable.

### SUMMARY OF THE INVENTION

An object of the present invention is to provide a double-tuned RF coil which solves a problem according to the prior arts described above comes into synchronization with two types of magnetic resonance frequencies with frequencies being close to each other to radiate an RF magnetic field with two types of magnetic resonance frequencies highly efficiently and uniformly and to receive two types of magnetic resonance signals at highly sensitive and uniform sensitivity distribution.

In order to solve the problems described above and to attain an object hereof, an RF coil of the present invention is an RF coil resonating at a first resonance frequency and a second resonance frequency respectively corresponding to a first element and a second element being different in magnetic resonance frequency, comprising at least one conductor loop, wherein the conductor loop has a first branch comprising a first capacitor and a second branch comprising a third capacitor and a first parallel resonance circuit configured by a second capacitor and a first inductor. For the RF coil, the first capacitor has capacity to allow the RF coil to resonate at the time of transmission and reception of the first resonance frequency signal at the occasion of the first resonance frequency being higher than the second resonance frequency, and capacity of the second capacitor and a value of the first inductor are determined as an accumulated value thereof based on the first resonance frequency and the third capacitor has such capacity that the resonance frequency for the series circuit configured by the first parallel resonance circuit and the third capacitor gets higher than the second resonance frequency at the time of transmission and reception of the second resonance frequency signal.

The RF coil of the present invention is specifically two conductor loops arranged opposite to each other on surfaces of cylinders and is applicable to a saddle-like coil connected with magnetic fields generated by the conductor loops being arranged in a mutually same direction, a double saddle type coil consisting of two saddle-like coils with one being arranged outward and the other being arranged inward to direct the magnetic field orthogonally, a birdcage type coil, a TEM coil, a surface coil having a single lead loop and a coil array having surfaces thereof in a combined fashion.

In the case of a birdcage type coil, the parallel circuit is installed, for example, in each of a plurality of line conductors. In that case, there adoptable is a configuration that at least one capacitor (fourth capacitor) is inserted in each link point between at least one loop conductor and the plurality of line conductors. Otherwise, the parallel circuit is installed in each link point between the loop conductor and a plurality of line conductors. In that case, there adoptable is a configuration that at least one capacitor (fourth capacitor) is installed in each of the plurality of line conductors.

As a property of the RF coil of the present invention, at least one capacitor is connected to the parallel circuit in series.

In addition, as a property of the RF coil of the present invention, a decoupling circuit is connected to a parallel circuit and enters an open state at the first resonance frequency and the second resonance frequency.

For the RF coil of the present invention, the second resonance frequency, for example, is not less than 80% of the first resonance frequency. Typically, the first element is hydrogen while the second element is fluorine.

An MRI apparatus of the present invention comprises a magnetostatic field forming unit for forming a magnetostatic field; a gradient magnetic field forming unit for forming a gradient magnetic field; an RF magnetic field forming unit for forming an RF magnetic field; a transceiver coil for applying the RF magnetic field to a test subject to detect a magnetic resonance signal from the test subject; a receiver unit for receiving the magnetic resonance signal; and a control unit for controlling the gradient magnetic field forming unit, the RF magnetic field forming unit and the receiver unit, wherein the RF coil of the present invention described above is used as a transceiver coil.

In addition, an MRI apparatus of the present invention comprises a magnetostatic field forming unit for forming a magnetostatic field; a gradient magnetic field forming unit for forming a gradient magnetic field; an RF magnetic field forming unit for forming an RF magnetic field; a transceiver coil for applying the RF magnetic field to a test subject; a receiver coil for detecting the magnetic resonance signal from the test subject; a receiver unit for receiving the magnetic resonance signal; and a control unit for controlling the gradient magnetic field forming unit, the RF magnetic field forming unit and the receiver unit, wherein the RF coil of the present invention described above is used at least as a coil of the transmitter or receiver coil. In that case, there used is the RF coil of the present invention comprising a decoupling circuit which is connected to a parallel circuit and enters an open state at the first resonance frequency and the second resonance frequency.

As the transmit coil, a birdcage type coil or a TEM coil is typically used. In addition, as the receiver coil, a one-turn surface coil and a coil array, for example, are used.

According to the present invention, it is possible to configure an RF coil capable of transmitting and receiving two types of magnetic resonance signals with frequencies being near each other without using capacitor and inductor having large values to an extent enough to accompany RF loss. Accordingly, the RF loss due to inductor and capacitor can be significantly reduced to improve reception sensitivity and transmit efficiency of the RF coil for the two types of magnetic resonance signals with frequencies being near each other. In addition, since the value of inductor that configures an RF coil and does not contribute to signal transmission and reception can be small, the RF coil improves in transmission and reception efficiency. Moreover, transmission and reception in the QD system is applicable to the RF coil capable of transmitting and receiving two types of magnetic resonance signals in which frequencies are relatively close together. Therefore, the RF coil improves in transmit efficiency and sensitivity for two types of magnetic resonance signals in which frequencies are relatively close together.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are diagrams illustrating appearance of an MRI apparatus to which the present invention is applied;

FIG. 2 is a block diagram illustrating a schematic configuration of a first embodiment of the MRI apparatus of the present invention;

FIG. 3 is a diagram illustrating a first embodiment (double-tuned loop coil) of a transceiver RF coil of the present invention;

FIG. 4 is a diagram illustrating an equivalent circuit of the double-tuned loop coil in FIG. 3 at a first resonance frequency;

FIG. 5 is a diagram illustrating a transceiver RF coil (double-tuned saddle type coil) of a second embodiment of the present invention;

FIG. 6 is a diagram illustrating positional relation between the double-tuned saddle type coil in FIG. 5 and a test subject;

FIGS. 7A and 7B are diagrams illustrating an example of combining two double-tuned saddle type coils;

FIG. 8 is a block diagram illustrating an example of connecting the coils in FIGS. 7A and 7B to a transceiver;

FIGS. 9A and 9B are diagrams illustrating a transceiver RF coil (double-tuned birdcage RF coil) of a third embodiment of the present invention;

FIG. 10 is a block diagram illustrating an example of connecting the double-tuned birdcage RF coil illustrated in FIGS. 9A and 9B to a transceiver;

FIG. 11 is a diagram illustrating a circuit configuration of a balun included in the circuit in FIG. 10;

FIGS. 12A and 12B are diagrams illustrating a variation of a double-tuned birdcage RF coil illustrated in FIGS. 9A and 9B;

FIGS. 13A and 13B are diagrams illustrating another variation of a double-tuned birdcage RF coil illustrated in FIGS. 9A and 9B;

FIGS. 14A and 14B are diagrams illustrating a configuration of a fourth embodiment (double-tuned TEM RF coil) of a transceiver RF coil of the present invention;

FIG. 15 is a block diagram illustrating a schematic configuration of a second embodiment of the MRI apparatus of the present invention;

FIGS. 16A and 16B are circuit diagrams of the first embodiment (transmitter double-tuned birdcage type coil) of the transmission RF coil of the present invention;

FIGS. 17A and 17B are circuit diagrams of the first embodiment (receive double-tuned coil) of the reception RF coil of the present invention;

FIGS. 18A and 18B are circuit diagrams of the second embodiment (double-tuned coil array) of the receive RF coil of the present invention;

FIG. 19 is a schematic diagram illustrating positional relation between the transmission double-tuned birdcage type coil in FIGS. 16A and 16B and the receive double-tuned coil in FIGS. 17A and 17B and relation of connection thereof to the transmitter and receiver;

FIG. 20 is a diagram illustrating a configuration of a conventional double-tuned RF coil; and

FIG. 21 is a diagram illustrating a conventional double-tuned saddle RF coil.

### DETAILED DESCRIPTION OF THE INVENTION

Preferable embodiments of an RF coil and an MRI apparatus on the present invention will be described in detail as follows. Here, the present invention will not be limited thereto.

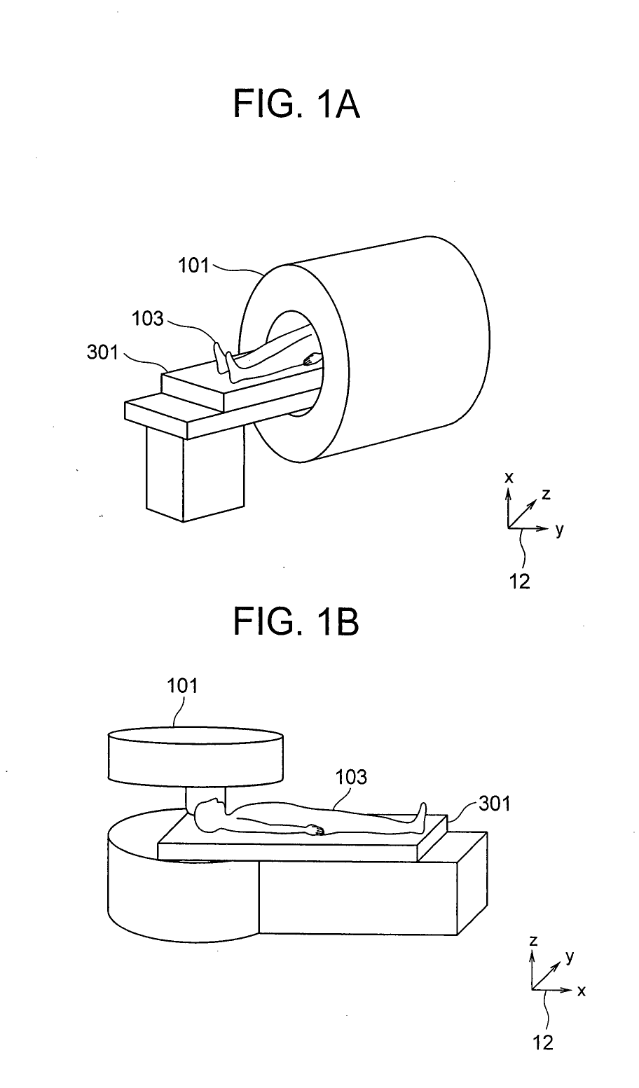

At first, an entire configuration of an MRI apparatus to which the present invention is applied will be described. FIGS. 1A and 1B are schematic diagrams illustrating appearance of an MRI apparatus and in diagrams a Z-axis direction is a magnetostatic direction. FIG. 1A is an MRI apparatus comprising a magnet 101 in a horizontal magnetic field system. A test subject 103 who is laid down on a table 301 is inserted into an image pickup space inside a bore of the magnet 101 undergoes image pickup. In FIG. 1B, the test subject 103 is inserted into the image pickup space between a pair of magnets located above and below respectively and undergoes image pickup with the magnet 101 in a vertical magnetic filed system. The present invention is applicable irrespective of the magnet system.

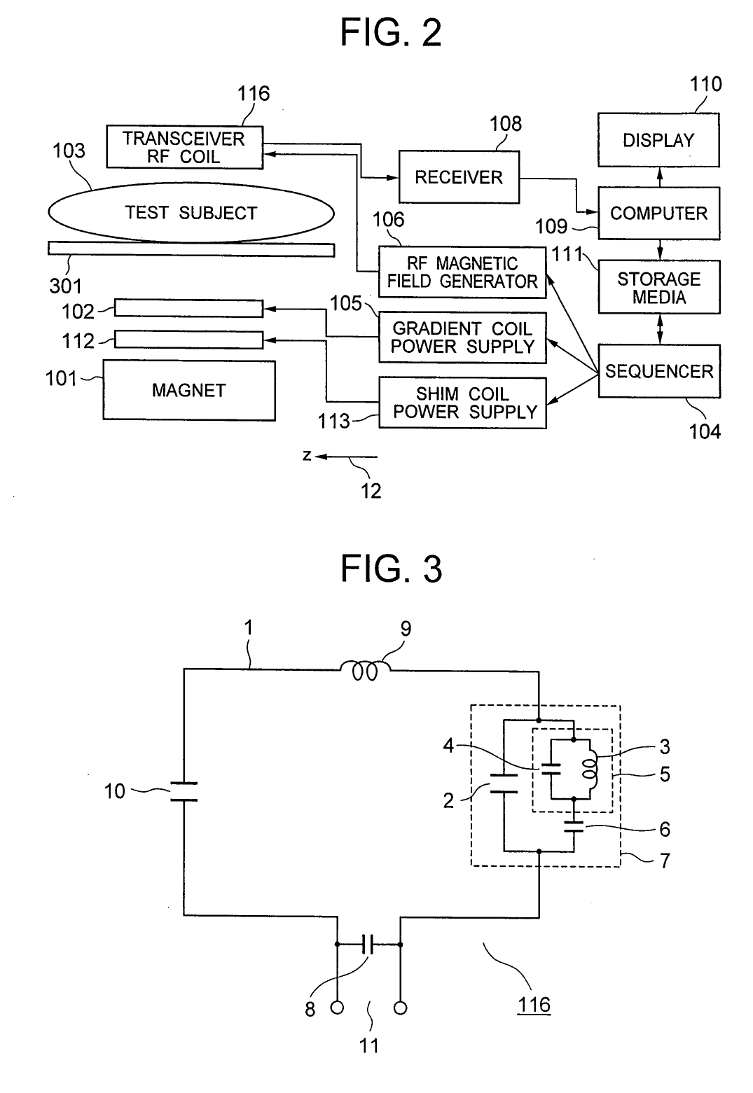

Next, an MRI apparatus according to a first embodiment of the present invention will be described. FIG. 2 is a block diagram illustrating a schematic configuration thereof. The same reference numerals are allocated to the likewise elements in FIGS. 1A and 1B. The illustrated MRI apparatus comprises a magnet 101 for generating static magnetic field, a gradient coil 102 for generating gradient magnetic field, a shim coil 112 for adjusting static magnetic field uniformity, a sequencer 104 and a transceiver RF coil 116 for generating an RF magnetic field and the like. The gradient coil 102 and the shim coil 112 are respectively connected to a gradient coil power supply 105 and a shim coil power supply 113. The transceiver RF coil 116 is connected to the RF magnetic field generator 106 and a receiver 108. The sequencer 104 transmits commands to the gradient coil power supply 105, the shim power supply 113 and the receiver 108 which are caused to generate the gradient magnetic field and the RF magnetic field respectively. The RF magnetic field is applied to the test subject 103 through the transceiver RF coil 116. The RF magnetic field is applied to detect RF signals generated from the test subject 103 with the transceiver RF coil 116 to carry out detection with the receiver 108. A magnetic resonance frequency to become a reference for detection at the receiver 108 is set with the sequencer 104. The detected signal is transmitted to a computer 109 through an A/D conversion circuit and signals undergo processing such as image reconfiguration there. The result thereof will be displayed on a display 110. The detected signal and measurement conditions are stored in a storage media 111 corresponding with necessity. The sequencer 104 normally controls respective apparatuses to operate at preprogrammed timing and intensity.

The MRI apparatus of the present embodiment comprises, as the transceiver RF coil 116, a double-tuned RF coil which comes in synchronization with two types of magnetic resonance frequencies, irradiates the RF magnetic field having two types of magnetic resonance frequencies highly efficiently and uniformly and receives two types of magnetic resonance signals with high sensitivity and at a uniform sensitivity distribution. An embodiment of a double-tuned loop coil used as the transceiver RF coil 116 will be described below.

FIG. 3 is a circuit diagram of a double-tuned loop coil illustrating a first embodiment of the present invention. The double-tuned loop coil of the present embodiment is used as a transceiver RF coil 116. The present loop coil comprises a loop conductor 1, a capacitor 10 disposed in the loop conductor 1, a parallel circuit 7 and a port 11. An inductor 9 (L₉) represents an equivalent inductance of the loop conductor 1. That value is 1 μH for a typical surface coil. The capacitor 10 and the parallel circuit 7 are disposed in the loop conductor 1 so that that loop coil resonates at two magnetic resonance frequencies. The parallel circuit 7 comprises a first branch path and a second branch path. In one branch path, a parallel resonance circuit 5 configured by a capacitor 4 and an inductor 3 is connected to a capacitor 6 in series. In the other branch path, a capacitor 2 is inserted. The inductor 3 is formed of an several-turn air core coil. In addition, a capacitor 8 for impedance adjustment is connected to the loop conductor 1 in order to match impedance of the loop coil viewed from the port 11 with impedance of the cable to be connected to the port 11.

The capacitor 10 and the capacitors 2, 4 and 6 and the inductor 3 configuring the parallel circuit 7 are adjusted to give appropriate values respectively in order that that loop coil resonates at two magnetic resonance frequencies. As follows, in the two resonance frequencies, a case with a first resonance frequency f₁ with higher frequency of proton magnetic resonance frequency 64 MHz in 1.5 T magnetic field intensity and second resonance frequency f₂ with lower frequency of fluorine magnetic resonance frequency 60 MHz in 1.5 T magnetic field intensity will be described as an example.

At first, values of the capacitor 2 and the capacitor 10 (C₂ and C₁₀) fulfill a following expression (1) so as to resonate with the inductor 9 (L₉) at the first resonance frequency f₁ (64 MHz),

$${ω}_{1}^{2} = \frac{1}{{L}_{9} \cdot \frac{{C}_{2} {C}_{10}}{{C}_{2} + {C}_{10}}} \qquad ( 1 )$$

and, undergo matching to fulfill a following expression (2).

$${C}_{10} > ( \frac{1 - {α}^{2}}{{α}^{2}} ) {C}_{2} \qquad ( 2 )$$

### Here, ω₁ is an angle frequency of a first resonant frequency f₁ and α=f₂/f₁. With the inductor 9 of the loop conductor 1 being L₉=1 μH, the typical value is C₂=16 pF and C₁₀=10 pF.

In addition, for the parallel resonance circuit 5, the values of the capacitor 4 (C₄) and the inductor 3 (L₃) undergo matching so as to resonate at the first resonance frequency f₁. The inductor 3 does not directly contribute to signal transmission and reception in the loop coil and, therefore, is desirably made remarkably smaller than the value of the inductor 9 (L₉=1 μH) in order to enhance transmission and reception efficiency. For example, the inductor 3 (L₃) is 50 nH. With L₃=50 nH, the typical value (C₄) of the capacitor 4 is 124 pF. In addition, the capacitor 6 is adjusted so that the capacitor 10 and the parallel circuit 7 form a series resonant system at a second resonance frequency f₂ (60 MHz) together with the inductor 9. The value (C₆) of the capacitor 6 at that occasion is expressed in the following expression (3).

$${C}_{6} = \frac{( {C}_{2} + {C}_{10} ) ( 1 - {α}^{2} )}{( 1 + \frac{{C}_{2}}{{C}_{4}} + \frac{{C}_{10}}{{C}_{2}} + \frac{{C}_{10}}{{C}_{4}} ) {α}^{2} - 1} \qquad ( 3 )$$

### C₆=5.2 pF will be derived from the values (C₂, C₄ and C₁₀) of the capacitors 2, 4 and 10.

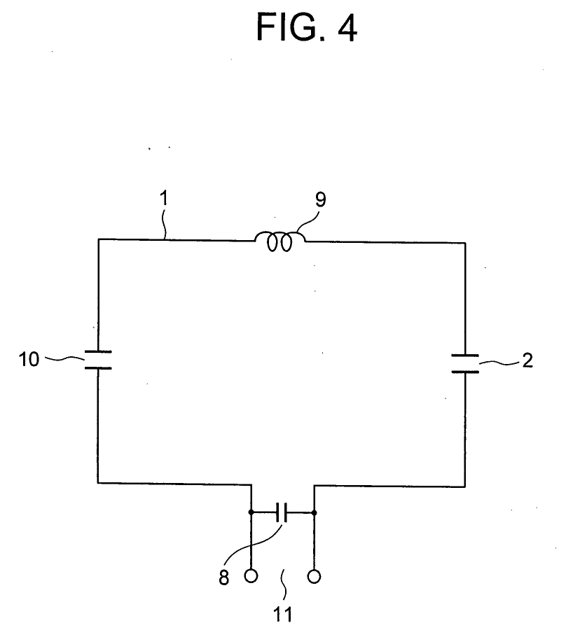

Next, the operation of the double-tuned loop coil having undergone matching as described above will be described. At first, an RF magnetic field generator 106 applies RF signals with frequency f₁ to a double-tuned loop coil. Then the parallel resonance circuit 5 will resonate at the frequency f₁ to come to an open state. Almost all of the RF signals applied to the loop coil will flow in the capacitor 2. Accordingly, the parallel circuit 7 functions as a capacitor. The loop coil can be regarded as a series circuit configured by the capacitor 2, the capacitor 10 and an inductor 9 as shown in FIG. 4. For that series circuit, the values of the capacitor 2, the capacitor 10 and the inductor 9 are adjusted to resonate at the frequency f₁. Therefore, the loop coil resonates at the frequency f₁ to apply an RF magnetic field at the frequency f₁ to the test subject 103. After application of the RF magnetic field, magnetic resonance signals with the frequency f₁ are radiated from the test subject 103. At that time, the double-tuned loop coil resonates at the frequency f₁ likewise the case of transmitting an RF signal with the frequency f₁ and detects, therefore, the proton magnetic resonance signals at high sensitivity. Accordingly, the loop coil illustrated in FIG. 3 operates as an RF coil for proton magnetic resonance signals.

In addition, the RF magnetic field generator 106 applies the RF signals with frequency f₂ to the double-tuned loop coil. The impedance (Z₁) of the loop coil will become as follows:

$${Z}_{l} = {jω}_{2} {L}_{9} + \frac{1}{{jω}_{2} {C}_{10}} + {Z}_{7} \qquad ( 4 )$$

Here, Z₇ represents the impedance of the parallel circuit 7. The impedance (Z₇) of the parallel circuit 7 at the frequency f₂ is expressed with:

$${Z}_{7} = \frac{1}{{jω}_{2}} \cdot \frac{1 - {ω}_{2}^{2} {L}_{3} ( {C}_{4} + {C}_{6} )}{( {C}_{2} + {C}_{6} ) - {ω}_{2}^{2} {L}_{3} ( {C}_{2} {C}_{4} + {C}_{2} {C}_{6} + {C}_{4} {C}_{6} )} \qquad ( 5 )$$

and with Z₇=1/jω₂X₇, the expression (4) is expressed as follows:

$$\begin{matrix}{Z}_{l} = {jω}_{2} {L}_{9} + \frac{1}{{jω}_{2} {C}_{10}} + \frac{1}{{jω}_{2} {X}_{7}} \\ = \frac{1}{{jω}_{2} {C}_{10} {X}_{7}} ( {X}_{7} ( 1 - {ω}_{2}^{2} {L}_{9} {C}_{10} ) + {C}_{10} ) .\end{matrix} \qquad ( 6 )$$

In order that the loop coil resonates at the frequency f₂, the expression (6) is required to fulfill:

X₇(1−ω₂²L₉C₁₀)+C₁₀=0 (7)

the expression (1) and α=f₂/f₁=ω₂/ω₁ derive the expression (7) to be:

$${X}_{7} = \frac{{C}_{10}}{( 1 + \frac{{C}_{10}}{{C}_{2}} ) {α}^{2} - 1} \qquad ( 8 )$$

### At that occasion, the conditions of the expression (2) results in X₇=0 and the parallel circuit 7 operates as a capacitor at a frequency f₂.

On the other hand, the expression (5) and the resonant condition ω₁²=1/(L₃C₄) of the parallel resonance circuit 5 makes X₇ be expressed with:

$${X}_{7} = {C}_{2} + \frac{{C}_{6} ( 1 - {α}^{2} )}{1 - ( 1 + \frac{{C}_{6}}{{C}_{4}} ) {α}^{2}} \qquad ( 9 )$$

Therefore, solving the expression (8) and the expression (9) on the capacitor C₆, the expression (3) is derived. Therefore, adjusting the capacitor C₆ so as to fulfill the expression (3), the loop coil illustrated in FIG. 3 resonates at the frequency f₂ to apply the RF magnetic field of the frequency f₂ to the test subject 103. After application of an RF magnetic field, magnetic resonance signals with the frequency f₂ are radiated from the test subject 103. At that occasion, the loop coil illustrated in FIG. 3 resonates at the frequency f₂ likewise the case of transmitting the RF signals with the frequency f₂ to detect the fluorine nucleus magnetic resonance signals with high sensitivity. Accordingly, the loop coil illustrated in FIG. 3 operates as an RF coil for fluorine nucleus magnetic resonance signals.

As described above, according to the present embodiment, without inductors and capacitors having values not less than 1 μH or not less than 1 nF, an RF coil capable of transmitting and receiving two types of magnetic resonance signals with mutually close frequencies simultaneously is realizable. That enables reduction in RF loss of inductors and capacitors and improves receiving sensitivity and transmit efficiency of the RF coil for the two types of magnetic resonance signals. In addition, since the value of the inductor 3 configuring the parallel circuit 7 can be made remarkable smaller than the inductance of the loop conductor 1. Therefore, unnecessary electromagnetic energy stored in the inductor 3 can be reduced to an extreme extent and thereby transmission and reception efficiency of the RF coil at the two magnetic resonance frequencies is improved. In addition, the receiving sensitivity of the coil for two types of magnetic resonance signals and irradiation distribution of the RF magnetic field are same. Therefore, compared with the case of detecting two types of magnetic resonance signals with two coils, the region enabling detection of the two types of magnetic resonance signals with the likewise sensitivity distribution expands. Moreover, arranging the loop coil illustrated in FIG. 3 close to a portion of the test subject 103, enabling detection of the two types of the magnetic resonance signals in the circumference of the tightly adhered portion with high sensitivity.

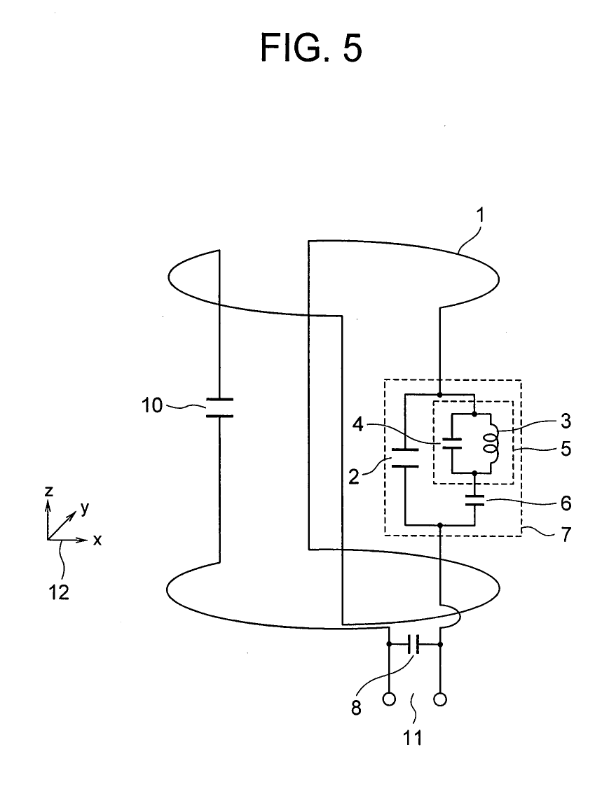

FIG. 5 illustrates a configuration of a double-tuned saddle type coil being a second embodiment of the present invention. The coil of the present embodiment can be used as a transceiver RF coil 116 as well. The configuration in FIG. 5 is different from the embodiment in FIG. 3 in the point that the two opposite loops are connected to generate a magnetic field in the same direction in the loop conductor 1 and the respective loops have the planes presenting a shape subject to deformation so as to go along the virtual cylindrical side plane, that is a saddle type coil shape. The coil is shaped differently. However, the coil in FIG. 5 is the same as the loop coil in FIG. 3 in the circuit configuration and the operation principle. Accordingly, the coil illustrated in FIG. 5 operates as an RF coil for two magnetic resonance signals with mutually close two frequencies represented by combination of proton and fluorine nucleus. In addition, the saddle type coil has uniform sensitivity distribution in the region wider than that of the surface coil. A reciprocity theorem enables the saddle type coil to irradiate an RF magnetic field having uniform distribution in the region wider than that of the surface coil.

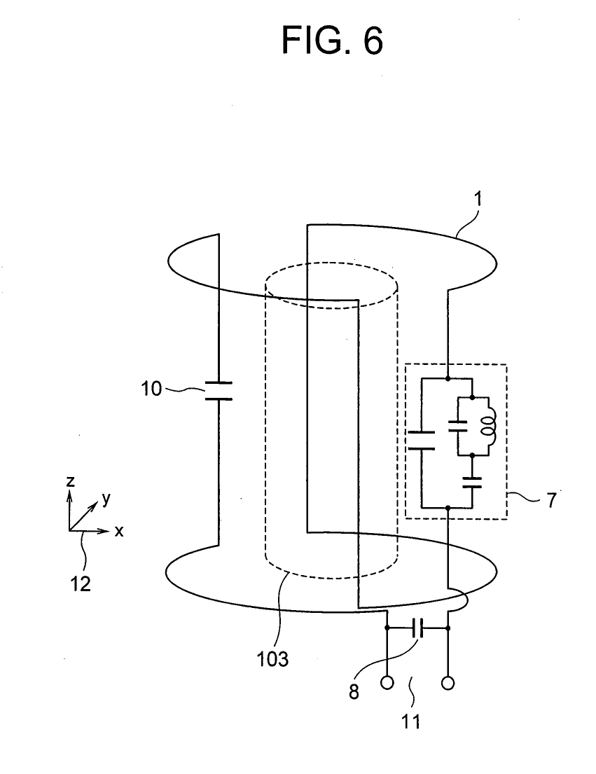

According to the present embodiment, an effect likewise the loop coil of the first embodiment is obtainable and moreover the coil is shaped like a saddle. Therefore, a test subject 103 such as arms, legs and a trunk of a test body is arranged in a saddle type coil as illustrated in FIG. 6. Thereby, two types of magnetic resonance signals are detectable with high sensitivity and uniform distribution across a region in the depth direction in addition to the surface of the test subject 103. Here, in the present embodiment, the loop conductor 1 illustrated in FIG. 5 is provided with a capacitor 10 and a parallel circuit 7. The loop conductor 1 can be provided with a plurality of capacitors 10 and a plurality of parallel circuits 7.

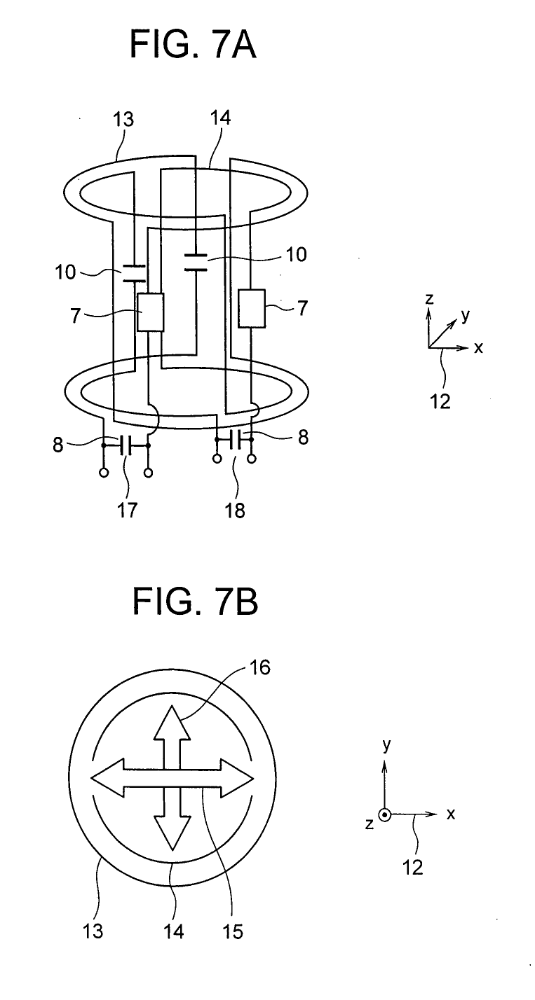

FIGS. 7A and 7B illustrate configurations of coils provided with two double-tuned saddle type coils illustrated in FIG. 5 in combination. The coil consists of a first double-tuned saddle type coil 13 and a second double-tuned saddle type coil 14 arranged in its inside. For those double-tuned saddle type coils 13 and 14, the loop planes of the respective coils are arranged to go in parallel along the axis Z of the axis 12 illustrated in FIG. 7A and the first double-tuned saddle type coil 13 and the second double-tuned saddle type coil 14 are arranged to be located subject to mutual rotation by 90 degrees around the axis z of the axis 12 as the rotation axis. FIG. 7B is a diagram of the double-tuned saddle type coil viewed from the direction of the axis z in FIG. 7A. As illustrated in FIG. 7B, the direction 15 of the magnetic field generated by the first double-tuned saddle type coil 13 is orthogonal to the direction 16 of the magnetic field generated by the second double-tuned saddle type coil 14. Therefore, the first double-tuned saddle type coil 13 and the second double-tuned saddle type coil 14 do not link magnetically each other and respectively can operate as RF coils for two types of magnetic resonance signals independently.

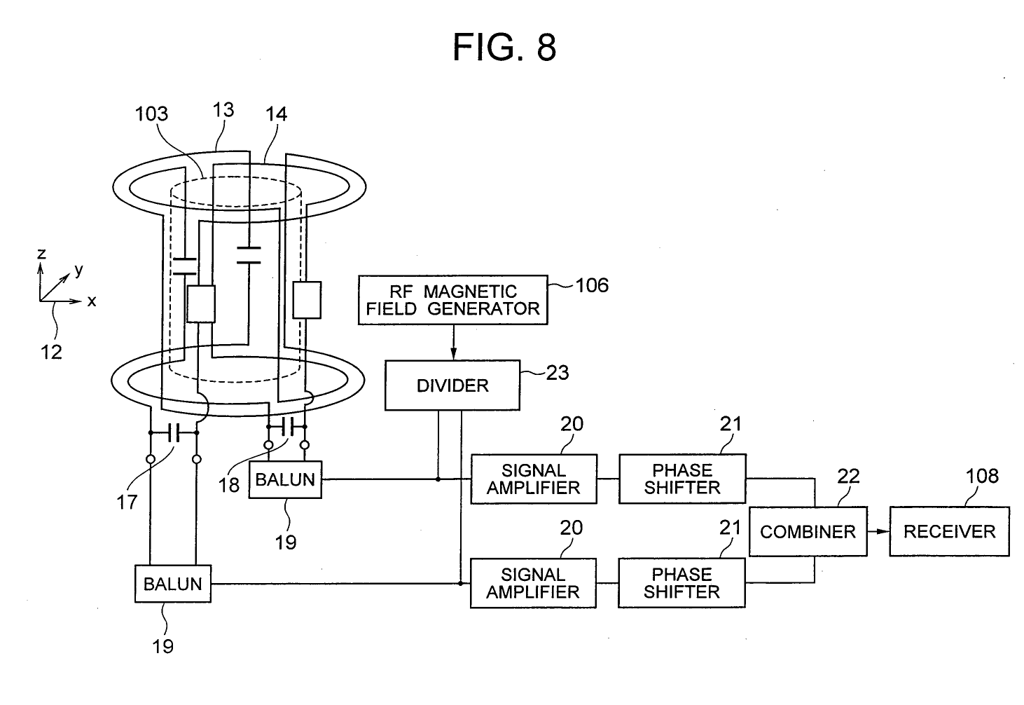

FIG. 8 illustrates an example of connecting the coil in FIG. 7A to a transceiver. An output of the RF magnetic field generator 106 is connected to a divider 12 and divided into two portions. The respective outputs are connected to a first port 17 and a second port 18 via baluns 19. In addition, the outputs from the two double-tuned saddle type coils are connected to the signal amplifiers 20 through the baluns 19. The outputs of the signal amplifiers 20 are inputted to a combiner 22 through phase shifters 21. The outputs thereof are connected to a receiver 108.

In such a configuration, RF signals of the first resonance frequency f₁ and second resonance frequency f₂ are transmitted by the RF magnetic field generator 106. Then the signals are divided with the divider 23 into two portions which have a phase difference of 90 degrees and are respectively applied to the first port 17 and the second port 18 through the baluns 19. The first and the second double-tuned saddle type coils 13 and 14 resonate at the first resonance frequency f₁ and the second resonance frequency f₂. Therefore, the RF signals transmitted from the RF magnetic field generator 106 are irradiated, as the RF magnetic field, to the test subject 103. At that occasion, the phases of the RF magnetic fields irradiated by the first and the second double-tuned saddle type coils 13 and 14 go orthogonal each other. Therefore, a rotating magnetic field is generated around the axis z of the axis 12 at the test subject 103. That is a so-called quadrature (QD) transmission system. In addition, the first and the second double-tuned saddle type coils 13 and 14 detect mutually orthogonal signal components for the magnetic resonance signals with first resonance frequency f₁ or the second resonance frequency f₂ generated from the test subject 103. The detected signals are respectively amplified by the signal amplifiers 20 to undergo processing at the phase shifters 21 and thereafter be synthesized with a combiner 22 and sent to the receiver 108. That is a so-called quadrature (QD) reception system.

Thus, the double-tuned saddle type coil of the present embodiment enables QD transmission and QD reception. Therefore, in addition to an effect according to the second embodiment, such a effect that the RF magnetic field is irradiated to the test subject 103 at higher efficiency to enable detection of two types of magnetic resonance signals with higher sensitivity. The loop conductor 1 can be provided with a plurality of capacitors 10 and a plurality of parallel circuits 7.

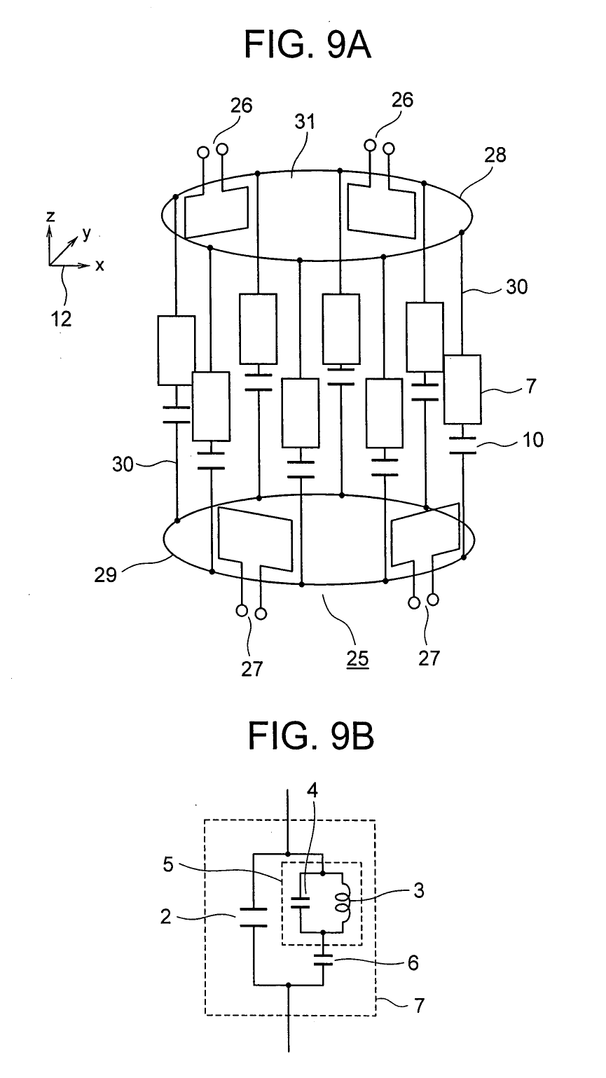

FIGS. 9A and 9B illustrate a configuration of a double-tuned birdcage RF coil 25 being a third embodiment of the present invention. The double-tuned birdcage RF coil 25 has, as illustrated in FIG. 9A, provided with two loop conductors 28 and 29 arranged in the mutually opposite locations with an axis orthogonal to the loop plane as the common axis and are connected with a plurality of line conductors 30 (eight units in FIGS. 9A and 9B) in parallel in the axial direction of the loop conductors 28 and 29. A parallel circuit 7 and a capacitor 10 are inserted to each of those line conductors 30 so that those coils resonate at two magnetic resonance frequencies. The parallel circuit 7 is structured likewise the parallel circuit 7 of the first and the second embodiments and is configured by, as illustrated in FIG. 9B, a capacitor 2 and a circuit including a capacitor 6 and a parallel resonance circuit 5 configured by a capacitor 4 and an inductor 3 connected in series.

In addition, in the loop plane 31 configured by the mutually adjacent two line conductors 30 and a portion of the loop conductors 28 and 29 bringing them into connection, there arranged are two pick-up coils 26 for transmitting and receiving the first resonance frequency signals and two pick-up coils 27 for transmitting and receiving the second resonance frequency signals as illustrated in FIG. 9A. For the two pick-up coils 26, the axes orthogonal to the loops of the pick-up coils 26 are arranged to go orthogonally each other so as to enable QD transmission and QD reception. That arrangement is also applicable to the pick-up coils 27. In addition, in order to minimize magnetic link between the pick-up coils 26 and the pick-up coils 27, positions of the pick-up coils 26 and 27 are adjusted in order that the loop plane 31 where the pick-up coil 26 is arranged is opposite each other to the loop plane 31 where the pick-up coil 27 is arranged. The pick-up coil 26 is arranged close to the loop conductor 28 and the pick-up coil 27 is arranged close to the loop conductor 29 respectively.

Here, indication of inductance of the loop conductors 28 and 29 and the line conductors 30 themselves is omitted in FIGS. 9A and 9B.

The capacitors 10 and the capacitors 2, 4 and 6 and the inductor 3 configuring the parallel circuit 7 are adjusted to give appropriate values respectively in order that that loop coil resonates at two magnetic resonance frequencies. As follows, in the two resonance frequencies, a case with a first resonance frequency f₁ with higher frequency of proton magnetic resonance frequency 64 MHz in 1.5 T magnetic field intensity and second resonance frequency f₂ with lower frequency of fluorine magnetic resonance frequency 60 MHz in 1.5 T magnetic field intensity will be described as an example.

The values of the capacitor 2 and the capacitor 10 (C₂ and C₁₀) are adjusted to allow the double-tuned birdcage RF coil 25 to resonate at the first resonance frequency f₁ (64 MHz). In addition, for the parallel resonance circuit 5, the values of the capacitor 4 (C₄) and the inductor 3 (L₃) undergo tuning so as to resonate at the first resonance frequency f₁. The inductor 3 does not directly participate in signal transmission and reception and, therefore, the value of the inductor 3 (L₃) is desirably made remarkably smaller than inductance of the loop configured by two line conductors 30 mutually adjacent to a portion of the loop conductors 28 and 29 in order to enhance transmission and reception efficiency. In addition, the capacitor 6 fulfills the expression (10):

$${C}_{6} < ( \frac{1 - {α}^{2}}{{α}^{2}} ) {C}_{4} \qquad ( 10 )$$

### The second resonance frequency f₂ (60 MHz) undergoes matching to fulfill the expression (3) so that the double-tuned birdcage RF coil 25 resonates.

$${C}_{6} = \frac{( {C}_{2} + {C}_{10} ) ( 1 - {α}^{2} )}{( 1 + \frac{{C}_{2}}{{C}_{4}} + \frac{{C}_{10}}{{C}_{2}} + \frac{{C}_{10}}{{C}_{4}} ) {α}^{2} - 1} \qquad ( 3 )$$

### The value (C₆) of the capacitor 6 is derived from the values (C₂, C₄ and C₁₀) of the capacitors 2, 4 and 10.

In the case where the double-tuned birdcage RF coil 25 illustrated in FIGS. 9A and 9B has dimensions of 30 cm diameter and 30 cm length, for example and the loop conductors 28 and 29 and the line conductors 30 have 5 mm diameter, the value of the inductor 3 (L₃) and the values of the capacitors 2, 4, 6, and 10 (C₂, C₄, C₆ and C₁₀) are 50 nH, 34 pF, 124 pF, 10.4 pF and 13 pF respectively.

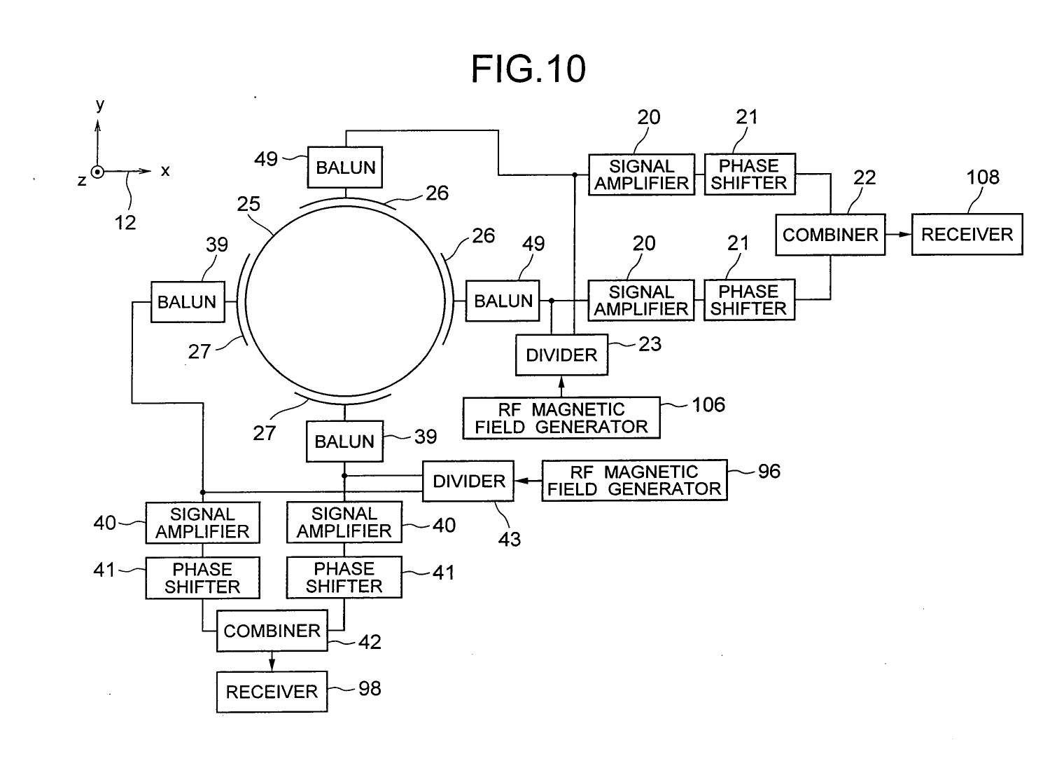

FIG. 10 illustrates an example of connecting the double-tuned birdcage RF coil 25 illustrated in FIGS. 9A and 9B to a transceiver. An output of the RF magnetic field generator 106 generating RF signals with the first resonance frequency is connected to a divider 23 and divided into two portions. The respective outputs are connected to pick-up coils 26 via baluns 49. An output of the RF magnetic field generator 96 generating RF signals with the second resonance frequency is connected to a divider 43 and divided into two portions. The respective outputs are connected to pick-up coils 27 via baluns 39. In addition, the output from the double-tuned birdcage RF coil 25 is transferred to the pick-up coils 26 and 27. The outputs from the two pick-up coils 26 are connected to the signal amplifiers 20 through the baluns 49. The outputs of the signal amplifiers 20 are inputted to a combiner 22 through a phase shifter 21. The output thereof is connected to a receiver 108. On the other hand, the outputs from the two pick-up coils 27 are connected to the signal amplifiers 40 through the baluns 39. The outputs of the signal amplifiers 40 are inputted to a combiner 42 through a phase shifter 41. The output thereof is connected to a receiver 98.

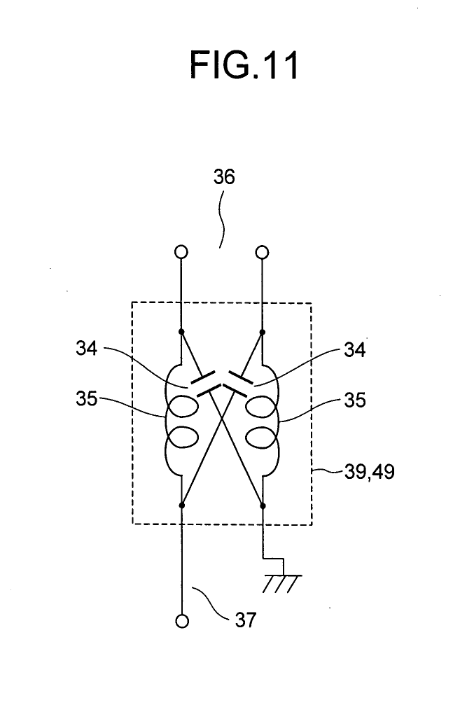

FIG. 11 illustrates a circuit diagram of the baluns 39 and 49 in FIG. 10. The baluns 39 and 49 are LC baluns of a bridge circuit type configured by capacitors 34 (C₃₄) and inductors 35 (L₃₅) and a port 36 is connected to the coil side. That circuit has a property to allow signals to pass only in the vicinity of the frequency attained by the following expression (11).

$${f}_{b} = \frac{1}{2 π \sqrt{{L}_{35} {C}_{34}}} \qquad ( 11 )$$

### The values of the capacitor 34 (C₃₄) and the inductor 35 (L₃₅) are adjusted to derive fb=f₁ for the balun 49 and fb=f₂ for the balun 39 respectively.

Next, the operation of the double-tuned birdcage RF coil 25 illustrated in FIGS. 9A, 9B and 10 will be described. RF signals of the first resonance frequency f₁ are transmitted by the RF magnetic field generator 106 illustrated in FIG. 10. Then the signals are divided with the divider 23 into two portions which have a phase difference of 90 degrees and are respectively applied to the two pick-up coils 26 through the baluns 49. The parallel resonance circuit 5 of the double-tuned birdcage RF coil 25 illustrated in FIGS. 9A and 9B will resonate at the frequency f₁ to come to an open state. Almost all of the RF signals applied to the double-tuned birdcage RF coil 25 will flow in the capacitor 2. Accordingly, the parallel circuit 7 functions as a capacitor. The value of the capacitor 2 is adjusted to make double-tuned birdcage RF coil resonate at the resonance frequency f₁. Therefore, the RF magnetic field with the first resonance frequency f₁ is irradiated to the test subject 103. At that occasion, the phases of the RF magnetic fields irradiated by the respective pickup coils 26 in the double-tuned birdcage RF coil 25 go orthogonal each other. Therefore, a rotating magnetic field is generated around the axis z of the axis 12 at the test subject 103. That is a so-called quadrature (QD) transmission system. In addition, the double-tuned birdcage RF coil 25 resonates at the frequency f₁ likewise at the occasion of RF magnetic field irradiation for the magnetic resonance signals with the first resonance frequency f₁ generated from the test subject 103 and, therefore, detects the magnetic resonance signals with the first resonance frequency f₁ at high sensitivity. The pick-up coils 26 and 27 illustrated in FIG. 10 detect mutually orthogonal signal components for the magnetic resonance signals with the first resonance frequency f₁ detected by the double-tuned birdcage RF coil 25 and transfer those signals to the baluns 39 and 49. The balun 49 has a property to allow signals to pass only in the vicinity of the first resonance frequency f₁. Therefore, the signals transferred to the baluns 39 and 49 are outputted only from the balun 49. The outputted signals from the balun 49 are amplified by the signal amplifiers 20 to undergo processing at the phase shifter 21 and thereafter the two received signals are synthesized with a combiner 22 and sent to the receiver 108. That is a so-called quadrature (QD) reception system.

RF signals of the second resonance frequency f₂ are transmitted by the RF magnetic field generator 96 illustrated in FIG. 10. Then the signals are divided with the divider 43 into two portions which have a phase difference of 90 degrees and are respectively applied to the two pick-up coils 27 through the baluns 39. When RF signals of the second resonance frequency f₂ are applied to the double-tuned birdcage RF coil 25, impedance of the parallel circuits 7 illustrated in FIGS. 9A and 9B presents capacitive according to conditions of the expression (2) and the expression (10) to function as a capacitor. The capacitor 6 is adjusted to a value determined by the expression (3). Thereby, the double-tuned birdcage RF coil 25 resonates at the frequency f₂. Therefore, the RF magnetic field with the second resonance frequency f₂ is irradiated to the test subject 103. At that occasion, the phases of the RF magnetic fields irradiated by the two pickup coils 27 in the double-tuned birdcage RF coil 25 go orthogonal each other. Therefore, a rotating magnetic field is generated around the axis z of the axis 12 at the test subject 103. That is a so-called quadrature (QD) transmission system. In addition, the double-tuned birdcage RF coil 25 resonates at the frequency f₂ likewise at the occasion of RF magnetic field irradiation for the magnetic resonance signals with the second resonance frequency f₂ generated from the test subject 103 and, therefore, detects the magnetic resonance signals with the second resonance frequency f₂ at high sensitivity. The pick-up coils 26 and 27 detect mutually orthogonal signal components for the magnetic resonance signals with the second resonance frequency f₂ detected by the double-tuned birdcage RF coil 25 and transfer those signals to the baluns 39 and 49. The balun 39 has a property to allow signals to pass only in the vicinity of the second resonance frequency f₂. Therefore, the signals transferred to the baluns 39 and 49 are outputted only from the balun 39. The outputted signals from the balun 39 are amplified by the signal amplifiers 40 to undergo processing at the phase shifter 41 and thereafter be synthesized with a combiner 42 and sent to the receiver 98. That is a so-called quadrature (QD) reception system.

As described so far, the present embodiment will become operable as an RF coil capable of concurrently transmitting and receiving two magnetic resonance signals with frequencies being close to each other without using capacitor and inductor having large values not less than 1 μH and not less than 1 nF. Thereby, the RF loss due to an inductor and a capacitor can be reduced to improve reception sensitivity and transmission efficiency of the RF coil for two magnetic resonance signals. In addition, the value of the inductor 3 configuring the parallel circuit 7 can be made remarkable smaller than the inductance of the loop conductor 1. Thereby, energy stored in the inductor 3 can be reduced so much as possible to improve transmit and reception efficiency of the RF coil in two magnetic resonance frequencies. In addition, since QD transmission and QD reception are feasible, an RF magnetic field can be irradiated at high efficiency to the test subject 103 to enable detection of two magnetic resonance signals at higher sensitivity. In addition, the birdcage type coil is higher than the saddle type coil in uniformity of irradiation distribution and sensitivity distribution of RF magnetic field. Therefore magnetic resonance image having higher image quality compared with the embodiments illustrated in FIGS. 5 and 7 are obtainable and are, in particular, effective for picking up the image of a head.

Here, the example of connection to a transmitter and receiver illustrated in FIG. 10 comprises RF magnetic field generators 106 and 96 of two strains of the first resonance frequency and the second resonance frequency and the receivers 108 and 98. However, the RF magnetic field generator of one strain illustrated in FIG. 8 on the double-tuned saddle type coil and the receiver can also be used. In addition, on the contrary, for the double-tuned saddle type coil illustrated in FIG. 8, the RF magnetic field generators and the receivers of two systems illustrated in FIG. 10 can be used as well.

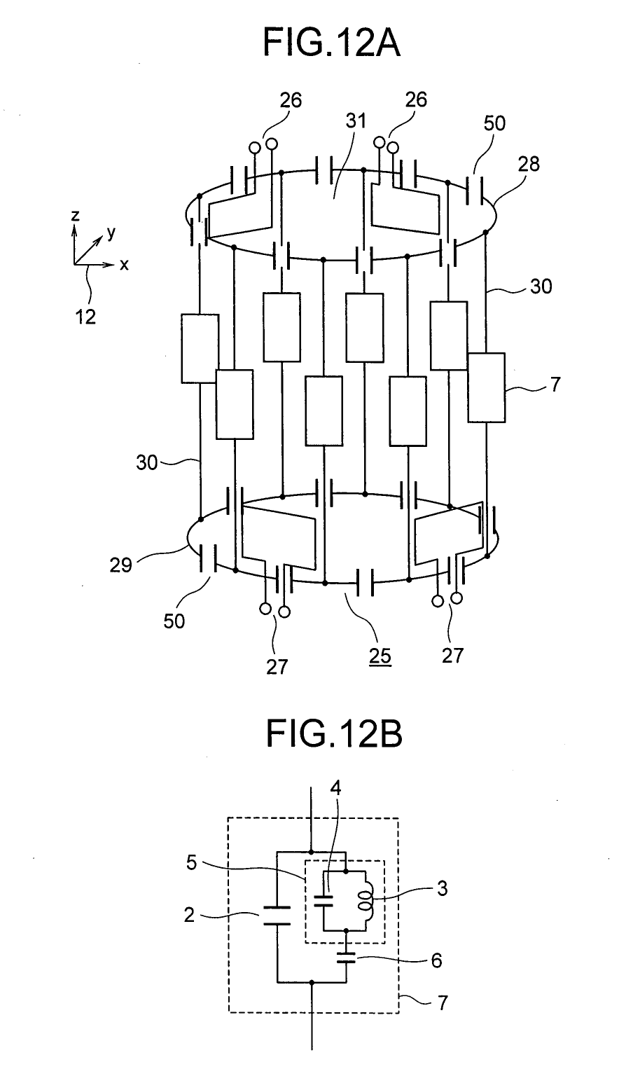

FIGS. 12A and 12B illustrate a variation of the double-tuned birdcage RF coil 25 illustrated in FIGS. 9A and 9B. That RF coil is different from the embodiment in FIGS. 9A and 9B in that the capacitor 50 is not inserted into the line conductor 30 but into the loop conductors 28 and 29. In the case where the capacitor 50 is inserted into the loop conductors 28 and 29, the values of the capacitors 2, 6 and 50 fluctuate. Nevertheless, the operation principle is likewise that for the double-tuned birdcage RF coil 25 illustrated in FIGS. 9A and 9B. Accordingly, the coil illustrated in FIGS. 12A and 12B operates as an RF coil for two magnetic resonance signals with mutually close two frequencies represented by combination of proton and fluorine nucleus.

In the case where the double-tuned birdcage RF coil 25 illustrated in FIGS. 12A and 12B has dimensions of 30 cm diameter and 30 cm length, and the loop conductors 28 and 29 and the line conductors 30 have 5 mm diameter, the value of the inductor 3 (L₃) and the values of the capacitors 2, 4, 6, and 50 (C₂, C₄, C₆ and C₅₀) are 50 nH, 26 pF, 124 pF, 7.4 pF and 50 pF respectively.

For the double-tuned birdcage RF coil of the present embodiment, the capacitor can be inserted into the both of the loop conductors 28 and 29 and the line conductor 30. That enables changes in the value of the capacitors even though the birdcage type coil with the same dimensions to enhance the degree of freedom in design on the values of the capacitors. Accordingly, in addition to an effect by the embodiment in FIGS. 9A and 9B, the RF coil of the present embodiment gives rise to an effect that the parallel circuit 7 will allow higher freedom in designing to simplify designing of the double-tuned birdcage RF coil 25. Here, the double-tuned birdcage RF coil in FIGS. 9A and 9B is a low-pass type due to reduced number of devices. In contrast, the birdcage RF coil of the present embodiment is a high-pass type.

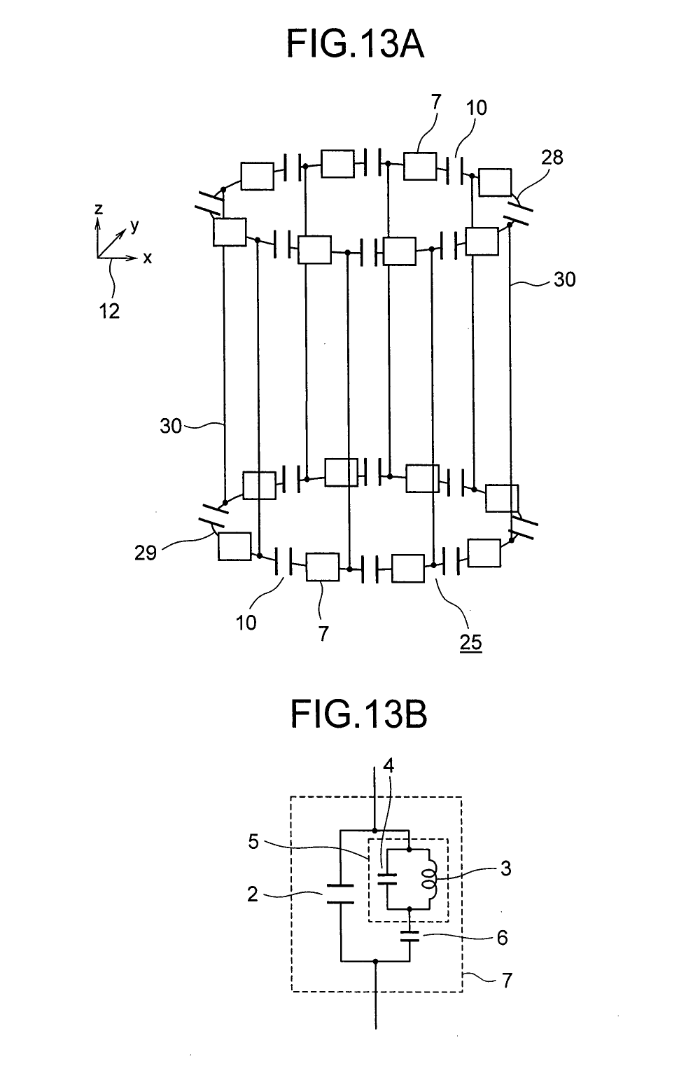

FIGS. 13A and 13B illustrate another variation of the double-tuned birdcage RF coil 25 illustrated in FIGS. 9A and 9B. That RF coil is different from the embodiment in FIGS. 9A and 9B in that the parallel circuit 7 and the capacitor 10 are not inserted into the line conductor 30 but into the loop conductors 28 and 29. Here in FIGS. 13A and 13B, the disposition of the pick-up coils 26 and 27 is omitted in order to make the drawing eye-friendly. In the case where parallel circuit 7 and the capacitor 10 are inserted into the loop conductors 28 and 29, the values of the capacitors 2, 6 and 10 are chanced. Nevertheless, the operation principle is likewise that of the double-tuned birdcage RF coil 25 illustrated in FIGS. 9A and 9B. Accordingly, the coil illustrated in FIGS. 13A and 13B operates as an RF coil for two magnetic resonance signals with mutually close to frequencies represented by combination of proton and fluorine nucleus.

In the case where the double-tuned birdcage RF coil 25 illustrated in FIGS. 13A and 13B has dimensions of 30 cm diameter and 30 cm length, and the loop conductors 28 and 29 and the line conductors 30 have 5 mm diameter, the value of the inductor 3 (L₃) and the values of the capacitors 2, 4, 6, and 50 (C₂, C₄, C₆ and C₅₀) are 50 nH, 89 pF, 124 pF, 12 pF and 50 pF respectively.

In the embodiment hereof, the parallel circuit 7 and the capacitor 10 are not arranged in the line conductor 30. Therefore, at the time of capturing an image of the head of a test body (patient), the parallel circuit 7 and the capacitor 10 will not hamper sight. Accordingly, in addition to an effect attained by the embodiment in FIGS. 9A and 9B, mental pressure to a subject (patient) can be advantageously alleviated.

Here, also in the present embodiment, a capacitor can be inserted into the line conductor 30 likewise the embodiment illustrated in FIGS. 12A and 12B. Thereby freedom in designing the parallel circuit 7 is improved to enable designing on the double-tuned birdcage RF coil 25 to be simple. At that occasion, the location of the capacitor is arranged in the vicinity of the both ends of the line conductor 30. Thereby without hampering sight of the subject (patient), it is possible to simplify designing of the double-tuned birdcage RF coil. In addition, the double-tuned birdcage RF coil illustrated in FIGS. 12A and 12B and in FIGS. 13A and 13B can be connected to the transceiver in one system as illustrated in FIG. 8 or in two systems as illustrated in FIG. 10 and is operated likewise the double-tuned birdcage RF coil in FIGS. 9A and 9B.

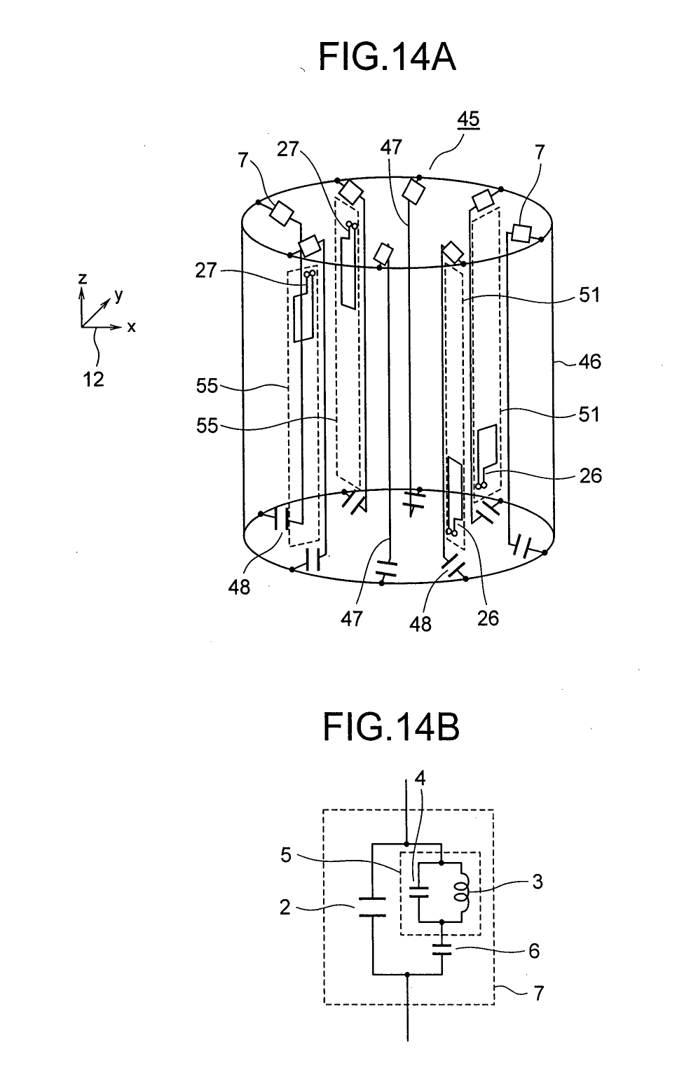

Next, a double-tuned TEM RF coil being a fourth embodiment of the present invention will be described. The RF coil of the present embodiment is also used as an RF coil 116 for transmission and reception. FIGS. 14A and 14B illustrate a configuration of the present coil. That double-tuned TEM RF coil 45 is, as illustrated in FIGS. 14A and 14B, provided with a plurality of line conductors 47 (eight units in FIGS. 13A and 13B) in parallel along the axis of a cylinder conductor 46 arranged inside the cylinder conductor 46 in equal spacing in the circumference direction at a constant distance from the inner surface of the cylinder conductor 46. Both ends thereof are connected to the inside of the cylinder conductor 46. A capacitor 48 and a parallel circuit 7 are inserted into the connecting portion of the line conductor 47 and the cylinder conductor 46 so that that coil resonates at two magnetic resonance frequencies. The parallel circuit 7 is likewise the parallel circuit 7 in the first to the third embodiments, and as illustrated in FIG. 14B, is configured by a circuit in which the parallel resonance circuit 5 configured by the capacitor 4 and the inductor 3 are connected in series to capacitor 6 and the capacitor 2.

In that double-tuned TEM RF coil, each line conductor 47 configures each loop together with the interior of the cylinder conductor 46. Two pick-up coils 26 for transmitting and receiving first resonance frequency signals and two pick-up coils 27 for transmitting and receiving second resonance frequency signals are arranged in four loop positions 51 and 55 among those loops. The two pick-up coils 26 are arranged so that axes orthogonal to the loop orthogonal with each other. Likewise, the two pick-up coils 27 are arranged so that axes orthogonal to the loop orthogonal with each other. The pick-up coils 26 and the pick-up coils 27 are arranged in the vicinity of the different ends of the cylinder conductor 46 in order to nullify magnetic coupling.

Here, the side plane of the cylinder conductor 46 illustrated in FIG. 14A is transparent so that the positional relation among a plurality of line conductors 47 inside the cylinder conductor 46 can be seen. However, actually the side plane of the cylinder conductor 46 is covered by conductor. In addition, indication of inductance of the cylinder conductor 46 and the line conductors 7 themselves is omitted in FIG. 14A. Relation of connection between the double-tuned TEM RF coil 45 of the present embodiment and the transceiver is likewise that in FIG. 10.

Adjustment of the capacitor and the inductor in the double-tuned TEM RF coil 45 of the present embodiment will be described, as an example, with a case with a first resonance frequency f₁ with proton magnetic resonance frequency 64 MHz in 1.5 T magnetic field intensity and a second resonance frequency f₂ with fluorine magnetic resonance frequency 60 MHz in 1.5 T magnetic field intensity.

The values (C₂ and C₄₈) of the capacitors 2 and 48 have been adjusted so that the double-tuned TEM RF coil 45 resonates at the first resonance frequency f₁ (64 MHz). In addition, the values of the capacitor 4 (C₄) and the inductor 3 (L₃) have been adjusted so that the parallel resonance circuit 5 illustrated in FIG. 14B resonates at the first resonance frequency f₁. The inductor 3 does not directly participate in signal transmission and reception and, therefore, the value of the inductor 3 (L₃) is desirably made remarkably smaller than inductance of the loop configured by a portion of the cylinder conductor 46 and the line conductor 47 in order to enhance transmission and reception efficiency. In addition, the capacitor 6 fulfills the following expression (10):

$${C}_{6} < ( \frac{1 - {α}^{2}}{{α}^{2}} ) {C}_{4} \qquad ( 10 )$$

and is adjusted to fulfill the expression (12) in order for the double-tuned TEM RF coil 45 to resonate at the second resonance frequency f₂ (60 MHz)

$${C}_{6} = \frac{( {C}_{2} + {C}_{48} ) ( 1 - {α}^{2} )}{( 1 + \frac{{C}_{2}}{{C}_{4}} + \frac{{C}_{48}}{{C}_{2}} + \frac{{C}_{48}}{{C}_{4}} ) {α}^{2} - 1} \qquad ( 12 )$$

Next, the operation in the case when the double-tuned TEM RF coil 45 of the present embodiment is connected to the transceiver as illustrated in FIG. 10 will be described. RF signal with the first resonance frequency f₁ is transmitted by the RF magnetic field generator 106. Then the signal is divided with the divider 23 into two portions which have a phase difference of 90 degrees and are respectively applied to the two pick-up coils 26 illustrated in FIGS. 14A and 14B through the baluns 49. The parallel resonance circuit 5 illustrated in FIG. 14B resonates at the frequency f₁ to come to an open state. Almost all of the RF signals applied to the double-tuned TEM RF coil 45 will flow through the capacitor 2. Accordingly, the parallel circuit 7 illustrated in FIG. 14A functions as a capacitor 2. The value of the capacitor 2 has been adjusted to make the double-tuned TEM RF coil 45 resonate at the first resonance frequency f₁. Therefore, the RF magnetic field with the first resonance frequency f₁ irradiates the test subject 103. At that occasion, the phases of the RF magnetic fields irradiated by the respective pickup coils 26 in the double-tuned TEM RF coil 45 go orthogonal each other. Therefore, a rotating magnetic field is generated around the axis of the cylinder conductor 46 at the test subject 103. That is a so-called quadrature (QD) transmission system. In addition, the double-tuned TEM RF coil 45 resonates at the frequency f₁ likewise at the occasion of RF magnetic field irradiation for the magnetic resonance signals with the first resonance frequency f₁ generated from the test subject 103 and, therefore, detects the magnetic resonance signals with the first resonance frequency f₁ at high sensitivity. The pick-up coils 26 and 27 illustrated in FIG. 14A detect mutually orthogonal signal components for the magnetic resonance signals with the first resonance frequency f₁ detected by the double-tuned TEM RF coil 45 and transfer those signals to the baluns 39 and 49 illustrated in FIG. 10. The balun 49 has a property to allow signals to pass only in the vicinity of the first resonance frequency f₁. Therefore, the signals transferred to the baluns 39 and 49 are outputted only from the balun 49. The signals output from the balun 49 are amplified by the signal amplifiers 20 to undergo processing at the phase shifter 21 and thereafter two received signals are synthesized with a combiner 22 and sent to the receiver 108. That is a so-called quadrature (QD) reception system.

RF signals of the second resonance frequency f₂ are transmitted from the RF magnetic field generator 96 illustrated in FIG. 10. Then the signals are divided with the divider 43 into two portions which have a phase difference of 90 degrees and are respectively applied to the two pick-up coils 27 illustrated in FIG. 14A through the baluns 39. When RF signals of the second resonance frequency f₂ are applied to the double-tuned TEM RF coil 45, impedance of the parallel circuits 7 illustrated in FIG. 14B presents capacitive according to conditions of the expression (2) and the expression (10) to function as a capacitor. The capacitor 6 is adjusted to a value determined by the expression (12). Thereby, the double-tuned TEM RF coil 45 resonates at the frequency f₂. Therefore, the RF magnetic field with the second resonance frequency f₂ is irradiated to the test subject 103. At that occasion, the phases of the RF magnetic fields irradiated by the double-tuned TEM RF coil 45 with the respective pickup coils 27 are orthogonal with each other. Therefore, a rotating magnetic field is generated around the axis of the cylinder conductor 46 at the test subject 103. That is a so-called quadrature (QD) transmission system. In addition, the double-tuned TEM RF coil 45 resonates at the frequency f₂ likewise at the occasion of RF magnetic field irradiation for the magnetic resonance signals with the second resonance frequency f₂ generated from the test subject 103 and, therefore, detects the magnetic resonance signals with the second resonance frequency f₂ at high sensitivity. The pick-up coils 26 and 27 detect mutually orthogonal signal components for the magnetic resonance signals with the second resonance frequency f₂ detected by the double-tuned TEM RF coil 45 and transfer those signals to the baluns 39 and 49 illustrated in FIG. 10. The balun 39 has a property to allow signals to pass only in the vicinity of the second resonance frequency f₂. Therefore, the signals transferred to the baluns 39 and 49 are output only from the balun 39. The signals output from the balun 39 are amplified by the signal amplifiers 40 to undergo processing at the phase shifter 41 and thereafter are synthesized with a combiner 42 and sent to the receiver 98. That is a so-called quadrature (QD) reception system.

As described so far, the double-tuned TEM RF coil of the present embodiment will become operable as an RF coil capable of concurrently transmitting and receiving two magnetic resonance signals with frequencies being close to each other. Since QD transmission and QD reception are feasible, an RF magnetic field can be highly efficiently irradiated to the test subject 103 to enable detection of two magnetic resonance signals at higher sensitivity. In addition, the TEM coil can irradiate an RF magnetic field highly efficiently at a frequency higher than the frequency of the birdcage type coil to enable detection of the magnetic resonance signals at high sensitivity. Therefore, even in the higher magnetic filed intensity of not less than 3 T, the present embodiment enables the coil to stably operate as an RF coil for two magnetic resonance signals with mutually close to frequencies represented by combination of proton and fluorine nucleus.

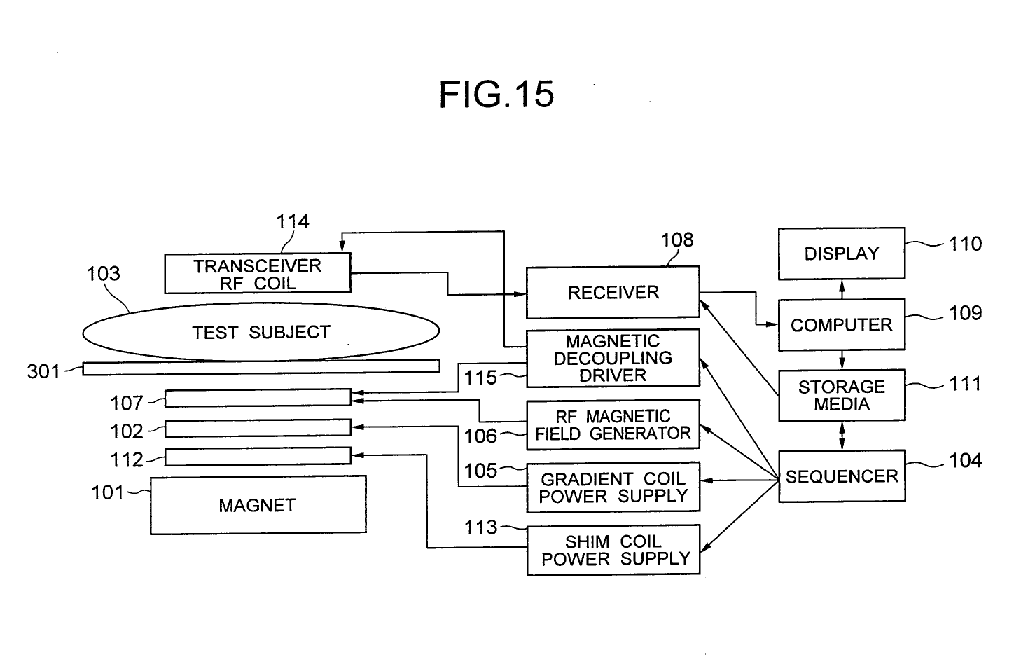

Next, a second embodiment of an MRI apparatus according to the present invention will be described. FIG. 15 is a block diagram illustrating a schematic configuration of the MRI apparatus according to a fifth embodiment of the present invention. In FIG. 15, the same reference numerals in the MRI apparatus of the first embodiment illustrated in FIG. 2 are allocated to the likewise elements. The MRI apparatus of the present embodiment is different from the apparatus illustrated in FIG. 2 in that the transmit RF coil 107 for transmitting an RF magnetic field and the receive coil 114 for receiving the RF signals generated from the test subject 103 are provided separately and those transmit RF coil 107 and receive RF coil 114 are switched with magnetic decoupling signal from the magnetic decoupling driver 115. At the time when an RF magnetic field is applied to the test subject 103 through the transmit RF coil 107, a magnetic decoupling signal is transmitted from the magnetic decoupling driver 115 to the receive RF coil 114 based on a command transmitted from the sequencer 104. Then the receive RF coil 114 will come to an open state to prevent magnetic coupling with the transmit RF coil 107. At the time of receiving the RF signal generated from the test subject 103 with the receive RF coil 114, the magnetic decoupling signal is transmitted from the magnetic decoupling driver 115 to the transmit RF coil 107 based on a command sent from the sequencer 104. Then the transmit RF coil 107 will come to an open state to prevent magnetic coupling with the receive RF coil 114. The other configurations and operations are likewise the MRI apparatus in FIG. 2.

Next, embodiments of the transmit RF coil and the receive RF coil adopted to the MRI apparatus of the present embodiment will be described.

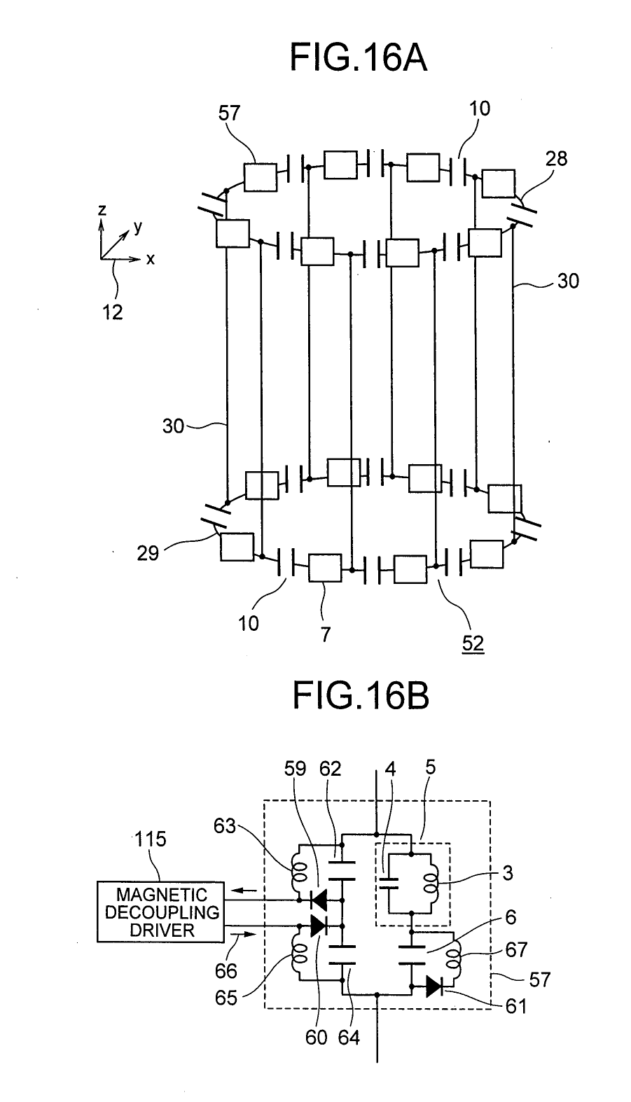

FIGS. 16A and 16B illustrate a double-tuned birdcage RF coil 52 as an embodiment of the transmit RF coil. The present coil is, as illustrated in FIG. 16A, structured likewise the double-tuned birdcage RF coil 25 illustrated in FIGS. 13A and 13B. However, in configuration, the parallel circuit 7 inserted into the loop conductor 28 is replaced by a parallel circuit 57.

As illustrated in FIG. 16B, the parallel circuit 57 comprises a circuit where a parallel resonance circuit 5 configured by the capacitor 4 and the inductor 3 is connected in series to the capacitor 6 and a circuit where the capacitor 62 is connected in series to the capacitor 64 being brought into connection in parallel. In addition, a circuit where a PIN diode 61 and the inductor 67 are brought into series connection is connected to the capacitor 6 in parallel; a circuit where a PIN diode 59 and the inductor 63 are brought into series connection is connected to the capacitor 62 in parallel; and a circuit where a PIN diode 60 and the inductor 65 are brought into series connection is connected to the capacitor 64 in parallel. The PIN diode has a property to approximately become a conductive state at not less than a constant value of direct current flowing in the forward direction of the diode. ON/OFF is controlled with direct current. In addition, the output terminal of the magnetic decoupling driver 115 is connected to the connection point of the PIN diode 60 and the inductor 65 and the connection point of the PIN diode 59 and the inductor 63. The diodes 59 to 61 of the parallel circuit 57 undergo ON/OFF control with control current from the magnetic decoupling driver 115. Thereby the present coil 52 functions as a transmit RF coil at the time of RF magnetic field transmission and presents high impedance so as not to intervene the receive RF coil at the time of RF signal reception. That operation will be described later.

That parallel circuit 57 sets the values of the capacitors 62 and 64 (C₆₂ and C₆₄) to be C₆₂=C₆₄=2C₂ with C₂ being the value of the capacitor 2 illustrated in FIG. 13B. The inductor 3 (L₃) and the values (C₄, C₆, C₆₂ and C₆₄) of the capacitors 4, 6, 62 and 64 are set with a method likewise that for the embodiment in FIGS. 13A and 13B. In addition, the value (L₆₃) of the inductor 63 is set so that the capacitor 62 and the inductor 63 resonate at a first resonance frequency f₁ when the PIN diode 59 is ON; the value (L₆₅) of the inductor 65 is set so that the capacitor 64 and the inductor 65 resonate at a second resonance frequency f₂ when the PIN diode 60 is ON; and the value (L₆₇) of the inductor 67 is set so that the capacitor 6 and the inductor 67 resonate at a second resonance frequency f₂ when the PIN diode 61 is ON.

Here, as the transmit RF coil, in addition to the structure illustrated in FIGS. 16A and 16B, there adoptable is a saddle type coil as illustrated in FIGS. 5, 7A and 7B; another birdcage RF coil illustrated in FIGS. 9A and 9B and FIGS. 12A and 12B; and a TEM RF coil as illustrated in FIG. 14A and FIG. 14B by replacing those parallel circuits 7 with the parallel circuits 57.

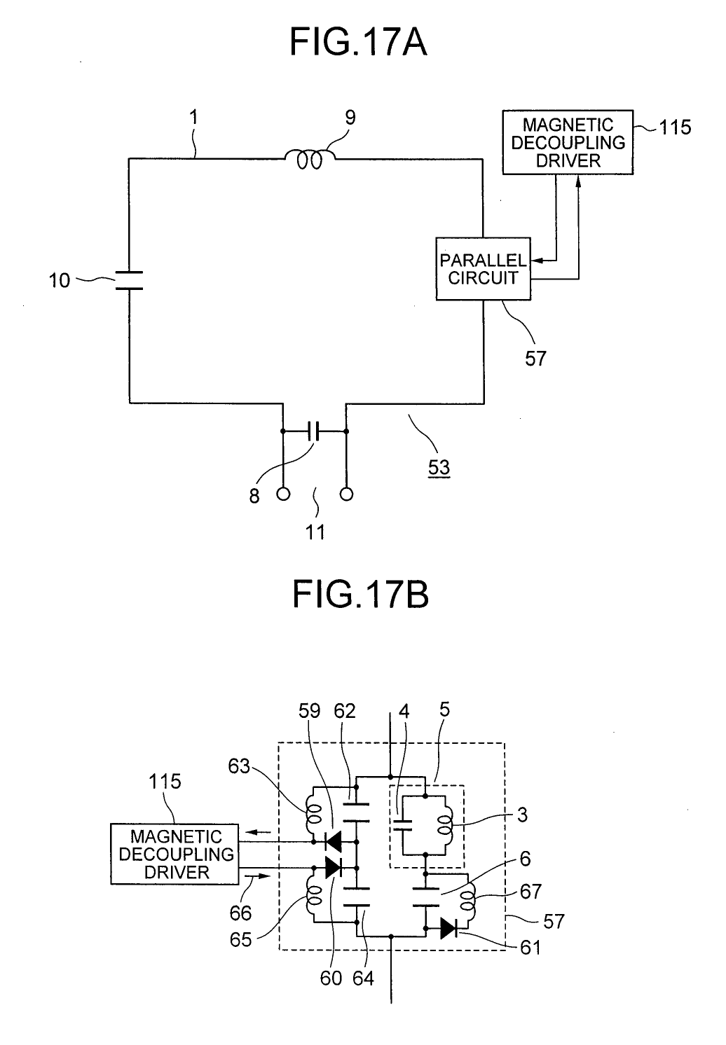

FIGS. 17A and 17B illustrate a double-tuned coil 53 as an embodiment of a receive RF coil. The present coil is structured similar to the double-tuned loop coil illustrated in FIG. 3 and is configured by replacing the parallel circuit 7 inserted into the loop conductor 1 with the parallel circuit 57 illustrated in FIG. 17B. That parallel circuit 57 is structured same as the parallel circuit 57 of the double-tuned birdcage RF coil 52 illustrated in FIGS. 16A and 16B. The diodes 59 to 61 of the parallel circuit 57 hereof also undergo ON/OFF control with control current from the magnetic decoupling driver 115. Thereby the present coil 52 functions as a receive RF coil at the time of RF magnetic field reception and presents high impedance so as not to intervene the receive RF coil at the time of RF magnetic field transmission. That operation will be described later.

The parallel circuit 57 sets the values of the capacitors 62 and 64 (C₆₂ and C₆₄) to be C₆₂=C₆₄=2C₂ with C₂ being the value of the capacitor 2 illustrated in FIG. 3. The inductor 3 (L₃) and the values (C₄, C₆, C₆₂ and C₆₄) of the capacitors 4, 6, 62 and 64 are set with a method likewise that for the embodiment in FIG. 3. In addition, the value (L₆₃) of the inductor 63 is set so that the capacitor 62 and the inductor 63 resonate at a first resonance frequency f₁ when the PIN diode 59 is ON; the value (L₆₅) of the inductor 65 is set so that the capacitor 64 and the inductor 65 resonate at a second resonance frequency f₂ when the PIN diode 60 is ON; and the value (L₆₇) of the inductor 67 is set so that the capacitor 6 and the inductor 67 resonate at a second resonance frequency f₂ when the PIN diode 61 is ON.

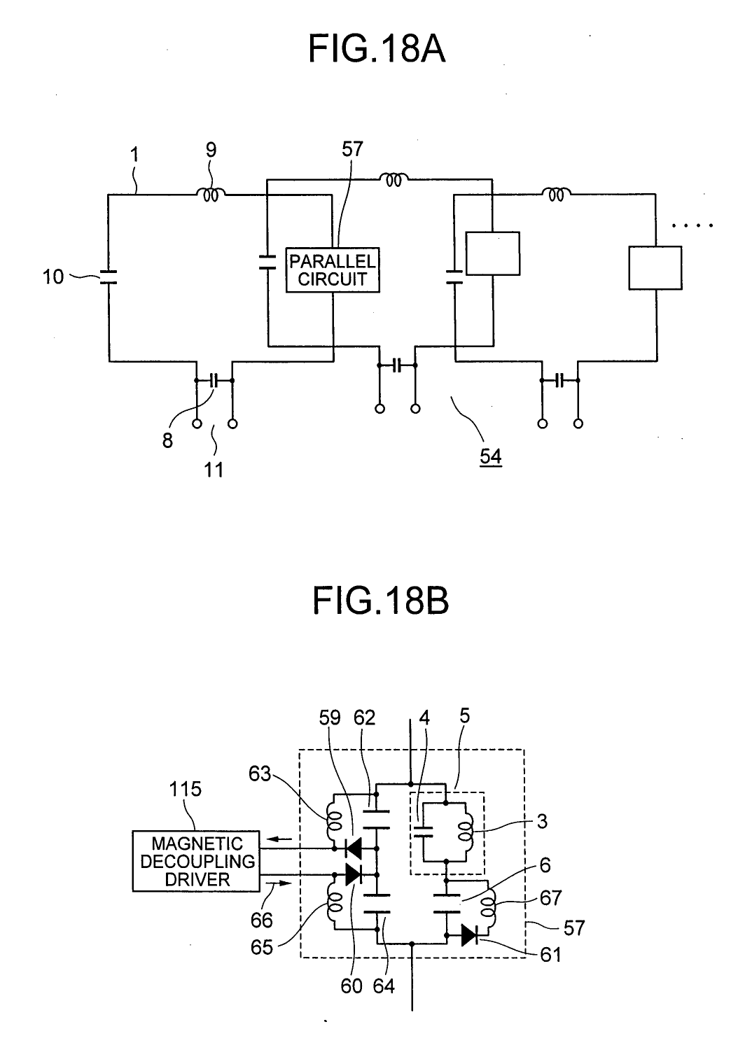

FIGS. 18A and 18B illustrate another embodiment of the receive RF coil. The coil illustrated in FIGS. 18A and 18B is configured by arranging the receive double-tuned coil 53 illustrated in FIGS. 17A and 17B in an array profile. Otherwise, as the receive RF coil, the loop conductor of the receive double-tuned coil 53 in FIG. 17 having undergone deformation, or a figure-of-eight RF coil, a saddle RF coil as illustrated in FIG. 5 and the like, for example, are adoptable.

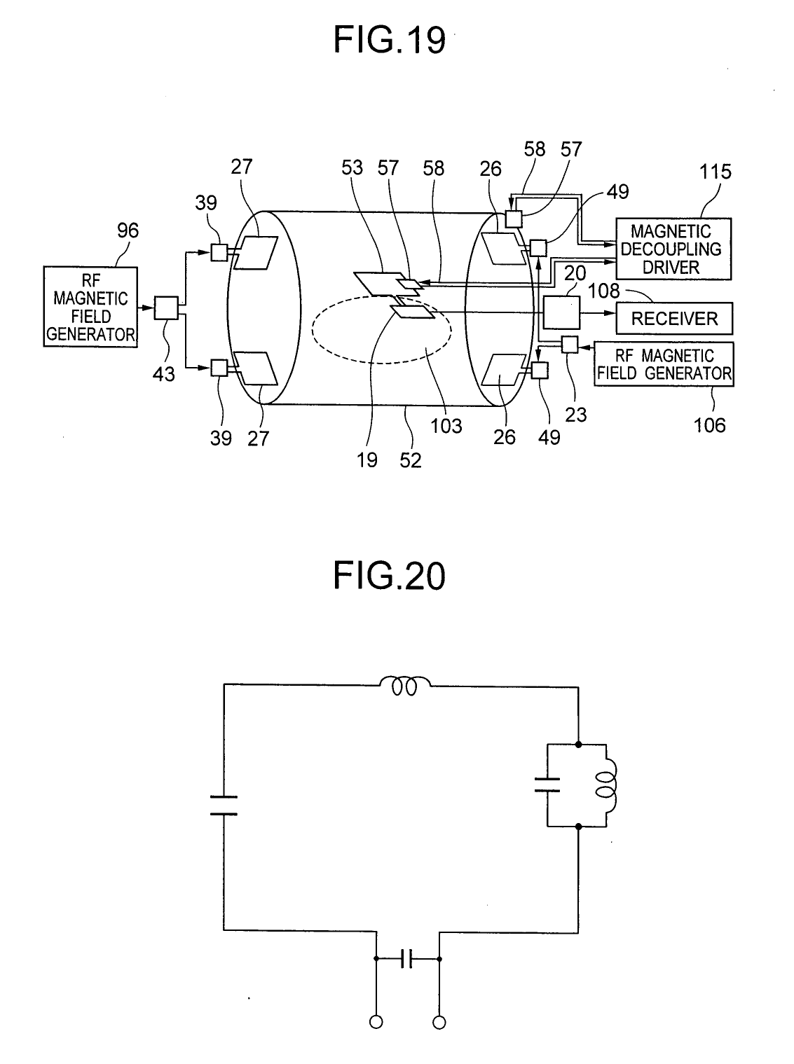

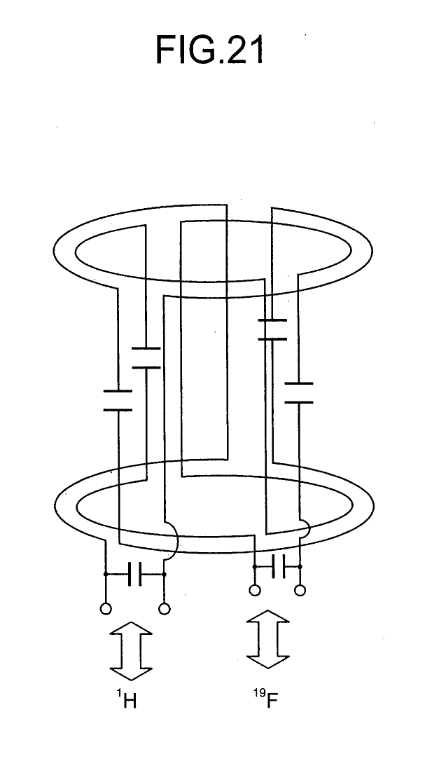

The above described positional relation between the transmit RF coil and the receive RF coil and relation of connection thereof to the transmitter and receiver will be described. FIG. 19 exemplifies a case of the above described transmit double-tuned birdcage RF coil 52 and the receive double-tuned coil 53. An output of the RF magnetic field generator 106 generating RF magnetic field with the first resonance frequency f₁ is connected to a divider 23 and divided into two portions. The respective outputs are connected to pick-up coils 26 via baluns 49. In addition, an output of the RF magnetic field generator 96 generating RF magnetic field with the second resonance frequency f₂ is connected to a divider 43 and divided into two portions. The respective outputs are connected to pick-up coils 27 via baluns 39. The pick-up coils 26 and 27 are arranged to transfer RF signals of the first and the second resonance frequencies (f₁ and f₂) to the transmit double-tuned birdcage RF coil 52 as shown in FIGS. 16A and 16B respectively. In addition, a plurality of control signal lines 58 are connected from the magnetic decoupling driver 115 to a plurality of parallel circuits 57 installed in the transmit double-tuned birdcage RF coil 52. In addition, the receive double-tuned coil 53 is arranged inside the transmit double-tuned birdcage RF coil 52 and arranged adjacent to the test subject 103. The output terminal of the receive double-tuned coil 53 is connected to the signal amplifier 20 via the balun 19 and connected to the receiver 108. In addition, a plurality of control signal lines 58 are connected from the magnetic decoupling driver 115 to a plurality of parallel circuits 57 installed in the receive double-tuned coil 53.

Next, with reference to FIGS. 16A and 16B and FIGS. 17A and 17B and FIG. 19, operation of the transmit double-tuned birdcage RF coil 52 and the receive double-tuned coil 53 will be described. In the case where the RF magnetic field generator 106 illustrated in FIG. 19 applies the RF magnetic field at the first resonance frequency f₁ to the transmit double-tuned birdcage RF coil 52, immediately prior thereto, the magnetic decoupling driver 115 set the value of the control current 66 flowing in the PIN diodes 59, 60 and 61 of the transmit double-tuned birdcage RF coil 52 illustrated in FIG. 16B to 0 and applies direct current control current 66 so as to turn ON the PIN diodes 59, 60 and 61 of the receive double-tuned coil 53 illustrated in FIG. 17B. The control current 66 is applied to the receive double-tuned coil 53. Thereby, the diodes 59, 60 and 61 illustrated in FIGS. 17A and 17B are turned ON so that the parallel resonance circuit configured by the capacitor 62 and the inductor 63 resonates at the first resonance frequency f₁, the parallel resonance circuit configured by the capacitor 64 and the inductor 65 and the parallel resonance circuit configured by the capacitor 6 and the inductor 67 resonates at the second resonance frequency f₂. In addition, the parallel resonance circuit consisting of the capacitor 4 and the inductor 3 resonates at the first resonance frequency f₁ and, therefore, the parallel circuit 57 will substantially enter an open state. Consequently, impedance of the receive double-tuned coil 53 gets extremely high.

On the other hand, for the transmit double-tuned birdcage RF coil 52 illustrated in FIGS. 16A and 16B, the value of the control current 66 flowing in the PIN diodes 59, 60 and 61 becomes 0. Thereby, the PIN diodes 59, 60 and 61 will get turned OFF. Then the parallel circuit 57 illustrated in FIG. 16B will become a circuit equivalent to the parallel circuit 7 illustrated in FIG. 13B so that the transmit double-tuned birdcage RF coil 52 operates as a coil which resonates at the first and the second resonance frequencies (f₁ and f₂). Accordingly, magnetic coupling between the transmit double-tuned birdcage RF coil 52 and the receive double-tuned coil 53 will be no longer present. The transmit double-tuned birdcage RF coil 52 can irradiate an RF magnetic field with the first resonance frequency f₁ onto the test subject 103 without causing resonance frequency shift due to magnetic coupling or decrease in the Q value in the coil. RF signals with the first resonance frequency f₁ are applied by the RF magnetic field generator 106. Then the signals are divided with the divider 23 into two portions which have a phase difference of 90 degrees and are respectively applied to the two pick-up coils 26 through the baluns 49. Also in the case where an RF magnetic field with the second resonance frequency f₂ is applied from the RF magnetic field generator 96 illustrated in FIG. 18 to the transmit double-tuned birdcage RF coil 52, likewise operation enables irradiation of the RF magnetic field with the second resonance frequency f₂ onto the test subject 103 without causing resonance frequency shift due to magnetic coupling between the transmit double-tuned birdcage RF coil 52 and the receive double-tuned coil 53 or decrease in the Q value in the coil.

After application of RF magnetic field, at an occasion of receiving magnetic resonance signals generated from the test subject 103, the magnetic decoupling driver 115 applies the control current 66 so as to turn on the PIN diodes 59, 60 and 61 of the transmit double-tuned birdcage RF coil 52 illustrated in FIG. 16B and sets the value of the control current 66 flowing in the PIN diodes 59, 60 and 61 of the receive double-tuned coil 53 illustrated in FIG. 17B to 0. Application of the control current 66 to the transmit double-tuned birdcage RF coil 52 turns on the PIN diodes 59, 60 and 61 illustrated in FIG. 16B. Then the parallel resonance circuit configured by the capacitor 62 and the inductor 63 resonates at the first resonance frequency f₁. The parallel resonance circuit configured by the capacitor 64 and the inductor 65 and the parallel resonance circuit configured by the capacitor 6 and the inductor 67 resonate at the second resonance frequency f₂. In addition, the parallel resonance circuit consisting of the capacitor 4 and the inductor 3 resonates at the first resonance frequency f₁ and, therefore, the parallel circuit 57 will enter an open state at the first and the second resonance frequencies (f₁ and f₂). Consequently, impedance of the transmit double-tuned birdcage RF coil 52 gets extremely high at the first and the second resonance frequencies (f₁ and f₂).

On the other hand, for the receive double-tuned coil 53, the value of the control current 66 flowing in the PIN diodes 59, 60 and 61 illustrated in FIG. 17B becomes 0. Thereby, the PIN diodes 59, 60 and 61 will get turned off. Consequently, the parallel circuit 57 illustrated in FIG. 17B will become a circuit equivalent to the parallel circuit 7 illustrated in FIG. 3 so that the receive double-tuned coil 53 operates as a coil which resonates at the first and the second resonance frequencies (f₁ and f₂).

Accordingly, at reception of two magnetic resonance signals corresponding to the first and the second resonance frequencies (f₁ and f₂) generated from the test subject 103, impedance of the transmit double-tuned birdcage RF coil 52 gets extremely high. Therefore, magnetic coupling between the transmit double-tuned birdcage RF coil 52 and the receive double-tuned coil 53 will be no longer present. The receive double-tuned coil 53 can receive two magnetic resonance signals corresponding to the first and the second resonance frequencies (f₁ and f₂) at high sensitivity and concurrently without causing resonance frequency shift due to magnetic coupling or decrease in the Q value in the coil. The signals received by the receive double-tuned coil 53 pass through the baluns 49, are amplified at the signal amplifier 20 and are received by the receiver 108 to undergo signal processing and are converted into a magnetic resonance image.

As described above, according to the present embodiment, impedance of the receive double-tuned coil 53 gets extremely high at RF magnetic field application and impedance of the transmit double-tuned birdcage RF coil 52 gets extremely high at reception of magnetic resonance signals. Thereby the transmitter coil and the receiver coil tuned to two magnetic resonance frequencies which are mutually close together will become preventable from mutual magnetic coupling. Consequently, it is possible for the transmitter coil to apply a uniform RF magnetic field provided with two types of magnetic resonance frequencies which are mutually close together and for the receiver coil to receive at high sensitivity and concurrently the two types of magnetic resonance signals which are mutually close together. Therefore, it will become possible to select the shape of the transmission coil and the shape of the reception coil independently. Use of double-tuned birdcage RF coil and TEM coil with highly uniform irradiation distribution as a transmit coil and selection of the shape of the receiver coil corresponding with the shape and dimensions of the test subject 103 enable image pickup of magnetic resonance image optimum to individual test subject 103. For example, use of the receive RF coil 54 illustrated in FIGS. 18A and 18B as a phased array coil enables image pickup in a extremely wider region compared with a single receive double-tuned coil 53 and enables highly sensitive and concurrent reception of two types of magnetic resonance signals, which are mutually close together, across the entire trunk of the body of a subject (patient) being the test subject 103.

Here, the above described embodiments have been described in the case of using a birdcage type coil as a transmitter RF coil and a surface coil as a receive RF coil. However, for the respective cases, any type can be used if the parallel circuit 7 of the transceiver RF coil described in the MRI apparatus of the first embodiment is replaced by the parallel circuit 57. In addition, in the case where the transmitter RF coil and the receive RF coil are separate, the case of use of the respective double-tuned RF coils of the present invention has been described. However, the present invention includes the case where the double-tuned RF coil of the present invention is adopted for only one of them.

It should be further understood by those skilled in the art that although the foregoing description has been made on embodiments of the invention, the invention is not limited thereto and various changes and modifications may be made without departing from the spirit of the invention and the scope of the appended claims.

1. An RF coil resonating at a first resonance frequency and a second resonance frequency respectively corresponding to a first element and a second element being different in magnetic resonance frequency, comprising at least one conductor loop,
wherein the conductor loop has a parallel circuit including a first branch comprising a first capacitor and a second branch comprising a third capacitor and a first parallel resonance circuit configured by a second capacitor and a first inductor;
the first capacitor has capacity to cause the RF coil to resonate at signal transmission and reception of the first resonance frequency when the first resonance frequency is higher than the second resonance frequency;
product of a value of the second capacitor and a value of the first inductor is determined as a value thereof based on the first resonance frequency; and
the third capacitor has such capacity that a resonance frequency for a series circuit configured by the first parallel resonance circuit and the third capacitor gets higher than the second resonance frequency at the time of transmission and reception of a second resonance frequency signal.

2. The RF coil according to claim 1, wherein:
two conductor loops arranged on a surface of a virtual cylinder substantially in plane symmetry on a plane along a center axis of the relevant virtual cylinder are connected so as to direct magnetic fields generated by the conductor loops in a mutually same direction to configure a saddle-like coil.

3. The RF coil according to claim 2, wherein:
two saddle-like coils different in radius are provided as the conductor loops; and
the two saddle-like coils different in radius have a common axis and are arranged so that directions of magnetic fields generated by the saddle-like coils are orthogonal to each other.

4. The RF coil according to claim 1, wherein:
at least one capacitor is connected in series to the parallel circuit.

5. The RF coil according to claim 1, wherein:
the RF coil is a birdcage RF coil configured by comprising two loop conductors arranged in mutually opposite locations and a plurality of line conductors with both ends being connected to those loop conductors in parallel in an axial direction of the axes of the loop conductors; and the adjacent two line conductors and a portion of the loop conductors connecting the two line conductors configure the conductor loop.

6. The RF coil according to claim 5, wherein:
the parallel circuit is installed at least one in number in each of the line conductors.

7. The RF coil according to claim 6, wherein:
at least one capacitor is inserted in at least one of the loop conductors between respective connection points where adjacent line conductors are brought into connection.

8. The RF coil according to claim 5, wherein
the parallel circuit is installed in each of the loop conductors between respective connection points where adjacent line conductors are brought into connection.

9. The RF coil according to claim 8, wherein:
at least one capacitor is installed in each of the line conductors.

10. The RF coil according to claim 1, wherein:
the RF coil is a TEM coil configured by comprising a cylinder conductor and a plurality of line conductors in parallel along an axis of the cylinder conductor arranged inside the cylinder conductor in equal spacing in a circumference direction at a constant distance from an inner surface of the cylinder conductor with both ends of each line conductor being connected to an inner surface of the a cylinder conductor with a conductor to form the conductor loop and the parallel circuit is installed in each line conductor or the conductor connecting each line conductor to the cylinder conductor.

11. The RF coil according to claim 10, wherein:
at least one capacitor is connected in series to the parallel circuit.

12. The RF coil according to claim 1, wherein:
the conductor loop is a surface coil configured by one-turn loop.

13. The RF coil according to claim 12, wherein:
a plurality of the surface coils are arranged substantially on a same plane to configure a array coil.

14. The RF coil according to claim 1, wherein:
the second resonance frequency is not less than 80% of the first resonance frequency.

15. The RF coil according to claim 14, wherein:
the first element is hydrogen while the second element is fluorine.

16. The RF coil according to claim 1, wherein:
a second parallel resonance circuit which enters an open state at the first resonance frequency and a third parallel resonance circuit which enters an open state at the second resonance frequency are connected to the parallel circuit.

17. An MRI apparatus comprising a magnetostatic field forming unit for forming a magnetostatic field; a gradient magnetic field forming unit for forming a gradient magnetic field; an RF magnetic field forming unit for forming an RF magnetic field; a transceiver coil for applying the RF magnetic field to a test subject to detect a magnetic resonance signal from the test subject; a receiver unit for receiving the magnetic resonance signal; and a control unit for controlling the gradient magnetic field forming unit, the RF magnetic field forming unit and the receiver unit, wherein:
the RF coil according to claim 1 is used as a transceiver coil.

18. An MRI apparatus comprising a magnetostatic field forming unit for forming a magnetostatic field; a gradient magnetic field forming unit for forming a gradient magnetic field; an RF magnetic field forming unit for forming an RF magnetic field; a transceiver coil for applying the RF magnetic field to a test subject; a receiver coil for detecting a magnetic resonance signal from the test subject; a receiver unit for receiving the magnetic resonance signal; and a control unit for controlling the gradient magnetic field forming unit, the RF magnetic field forming unit and the receiver unit, wherein:
the RF coil according to claim 16 is used as the transmitter coil.

19. An MRI apparatus comprising a magnetostatic field forming unit for forming a magnetostatic field; a gradient magnetic field forming unit for forming a gradient magnetic field; an RF magnetic field forming unit for forming an RF magnetic field; a transceiver coil for applying the RF magnetic field to a test subject; a receiver coil for detecting a magnetic resonance signal from the test subject; a receiver unit for receiving the magnetic resonance signal; and a control unit for controlling the gradient magnetic field forming unit, the RF magnetic field forming unit and the receiver unit, wherein:
the RF coil according to claim 16 is used as the receiver coil.

20. The MRI apparatus according to claim 18, wherein:
the RF coil according to claim 16 is used as the receiver coil.

21. The MRI apparatus according to claim 20, wherein:
the transmitter coil is a birdcage or TEM coil and the receiver coil is a surface coil or a array coil.

22. The MRI apparatus according to claim 17, wherein:
the RF magnetic field forming unit and the receiver unit configure one strain and a unit for dividing the one strain of the RF magnetic field forming unit and the receiver unit into a plurality of conductor loops is provided.

23. The MRI apparatus according to claim 17, wherein:
the RF magnetic field forming unit and the receiver unit configure two strains and one strain is connected to one of a plurality of conductor loops while the other strain is connected to other one of the plurality of conductor loops.

24. The RF coil according to claim 2, wherein:
at least one capacitor is connected in series to the parallel circuit.

25. The RF coil according to claim 3, wherein:
at least one capacitor is connected in series to the parallel circuit.
